(19) United States
(12) Patent Application Publication
(10) Pub. No.: US 2025/0303353 A1
(43) Pub. Date: Oct. 2, 2025

(54) GAS-LIQUID CONTACTOR FOR CAPTURING CARBON DIOXIDE

(71) Applicant: CARBON ENGINEERING ULC, Squamish (CA)

(72) Inventors: John Mitchell Pace, Cypress, TX (US); Robert Louis Zeller, III, Seabrook, TX (US)

(21) Appl. No.: 18/865,777

(22) PCT Filed: May 17, 2023
(86) PCT No.: PCT/US2023/022506

§ 371 Date: Nov. 14, 2024

Related U.S. Application Data
(60) Provisional application No. 63/342,864, filed on May 17, 2022.

(51) Int. Cl. B01D 53/14

(52) U.S. Cl. CPC B01D 53/1475; B01D 53/1425; B01D 53/1493; B01D 2252/10; B01D 2252/204; B01D 2252/602; B01D 2257/504; B01D 2259/124

(57) ABSTRACT

A system for removing carbon dioxide from a gas includes: an eductor, a CO₂-lean gas outlet fluidly coupled to the eductor, a fan fluidly coupled to the CO₂-lean gas outlet, the fan being rotatable to discharge the CO₂-lean gas from the CO₂-lean gas outlet, and a capture solution tank. The eductor includes a capture solution inlet operable to receive a lean capture solution, a gas inlet operable to receive the gas that includes carbon dioxide, a mixing zone configured to react the lean capture solution and the gas that includes carbon dioxide; and, an eductor outlet operable to discharge a mixed fluid that includes a rich capture solution and a CO₂-lean gas. The capture solution tank is fluidly coupled to the eductor outlet and to the CO₂-lean gas outlet, and the capture solution tank configured to collect the rich capture solution.

### CROSS-REFERENCE TO RELATED APPLICATIONS

This application claims priority to U.S. provisional patent application 63/342,864 filed May 17, 2022, the entire contents of which are incorporated by reference herein.

### TECHNICAL FIELD

This disclosure describes systems, apparatus, and methods for gas-liquid contacting for the recovery of carbon dioxide from gases.

### BACKGROUND

Capturing carbon dioxide (CO₂) from the atmosphere is one approach to mitigating greenhouse gas emissions and slowing climate change. However, many technologies designed for CO₂ capture from point sources, such as flue gas of industrial facilities, are generally ineffective in capturing CO₂ from the atmosphere due to the significantly lower CO₂ concentrations and large volumes of air required to process. In recent years, progress has been made in finding technologies better suited to capture CO₂ directly from the atmosphere. Some of these direct air capture (DAC) systems use a solid sorbent where an active agent is attached to a substrate. These DAC systems typically employ a cyclic adsorption-desorption process where, after the solid sorbent is saturated with CO₂, it releases the CO₂ using a humidity or thermal swing and is regenerated. While solid sorbent DAC systems can have a high cyclic yield, large scale deployment is a challenge due to maintenance requirements that are inherent to a batch process.

Other DAC systems use a liquid sorbent (sometimes referred to as a solvent) to capture CO₂ from the atmosphere. An example of such a gas-liquid contact system would be one that uses a fan to draw air across a high surface area packing that is wetted with a solution comprising the liquid sorbent. CO₂ in the air reacts with the liquid sorbent. The rich solution is further processed downstream to regenerate a lean solution and to release a concentrated CO₂ stream. Such DAC systems may be advantageous since they employ some commercially available equipment and they can operate more effectively in certain environments than others. It is desirable for DAC systems to be simply maintainable and operationally flexible.

### SUMMARY

In an example implementation, a system for removing carbon dioxide from a gas includes: an eductor, a CO₂-lean gas outlet fluidly coupled to the eductor, a fan fluidly coupled to the CO₂-lean gas outlet, the fan being rotatable to discharge the CO₂-lean gas from the CO₂-lean gas outlet, and a capture solution tank. The eductor includes a capture solution inlet operable to receive a lean capture solution, a gas inlet operable to receive the gas that includes carbon dioxide, a mixing zone configured to react the lean capture solution and the gas that includes carbon dioxide; and, an eductor outlet operable to discharge a mixed fluid that includes a rich capture solution and a CO₂-lean gas. The capture solution tank is fluidly coupled to the eductor outlet and to the CO₂-lean gas outlet, and the capture solution tank configured to collect the rich capture solution.

In an aspect combinable with the example implementation, the system includes a regeneration system fluidly coupled to the capture solution tank.

In another aspect combinable with any of the previous aspects, the system includes a capture solution distribution line fluidly coupled to the capture solution inlet of the eductor and to the regeneration system.

In another aspect combinable with any of the previous aspects, the capture solution tank is fluidly coupled to the regeneration system via a capture solution circulation pump.

In another aspect combinable with any of the previous aspects, the regeneration system includes at least one of a lime causticization system or a calciner.

In another aspect combinable with any of the previous aspects, the lime causticization system includes at least one of a pellet reactor or a slaker.

In another aspect combinable with any of the previous aspects, the calciner includes an electric calciner.

In another aspect combinable with any of the previous aspects, the regeneration system has a product conduit configured to provide the carbon dioxide as a product gas.

In another aspect combinable with any of the previous aspects, the system includes a mist eliminator fluidly coupled to the CO₂-lean gas outlet.

In another aspect combinable with any of the previous aspects, the mist eliminator includes a chevron-type mist eliminator.

In another aspect combinable with any of the previous aspects, the mist eliminator is positioned upstream of the fan.

In another aspect combinable with any of the previous aspects, the system includes a mixing chamber fluidly coupled to the eductor outlet.

In another aspect combinable with any of the previous aspects, the mixing chamber includes a static mixer.

In another aspect combinable with any of the previous aspects, the mixing chamber includes a rate-enhancing material coating.

In another aspect combinable with any of the previous aspects, the mixing chamber is positioned vertically between the eductor outlet and the capture solution tank.

In another aspect combinable with any of the previous aspects, the system includes a packed bed absorption column fluidly coupled to the CO₂-lean gas outlet.

In another aspect combinable with any of the previous aspects, the packed bed absorption column is positioned upstream of the fan.

In another aspect combinable with any of the previous aspects, the packed bed absorption column includes a structured packing.

In another aspect combinable with any of the previous aspects, the packed bed absorption column includes a rate-enhancing material coating.

In another aspect combinable with any of the previous aspects, the system includes a packed bed absorption column and a mist eliminator, wherein the mist eliminator, the packed bed absorption column, the fan and the CO₂-lean gas outlet are spaced apart vertically and sequentially from a lowest position to a highest position as follows: the packed bed absorption column, the mist eliminator, the fan and the CO₂-lean gas outlet.

In another aspect combinable with any of the previous aspects, the system includes a rate-enhancing material coating on at least one of the eductor, the capture solution tank, or a wetted surface.

In another aspect combinable with any of the previous aspects, the eductor is operable to flow a lean capture solution that includes a rate-enhancing additive.

In another aspect combinable with any of the previous aspects, the rate-enhancing additive includes at least one of piperazine, carbonic anhydrase, or monoethanolamine.

In another aspect combinable with any of the previous aspects, the system includes an auxiliary unit or an intermediate system fluidly coupled to the capture solution tank.

In another aspect combinable with any of the previous aspects, the eductor defines an eductor axis parallel to an axis extending between the capture solution inlet and the eductor outlet, and the fan is rotatable about a fan axis parallel to the eductor axis.

In another aspect combinable with any of the previous aspects, the eductor axis and the fan axis are horizontally spaced apart.

In another aspect combinable with any of the previous aspects, the capture solution tank is disposed beneath the eductor and the fan.

In another example implementation, a system for removing carbon dioxide from a gas includes: a plurality of eductors, at least one CO₂-lean gas outlet fluidly coupled to at least one eductor of the plurality of eductors, at least one fan fluidly coupled to the at least one CO₂-lean gas outlet, the at least one fan being rotatable to discharge CO₂-lean gas from the at least one CO₂-lean gas outlet, a capture solution tank, and a capture solution distribution line. Each eductor of the plurality of eductors includes a capture solution inlet operable to receive a lean capture solution, a gas inlet operable to receive the gas that includes carbon dioxide, a mixing zone configured to react the lean capture solution and the gas that includes carbon dioxide, and an eductor outlet operable to discharge a mixed fluid that includes a rich capture solution and CO₂-lean gas. The capture solution tank is fluidly coupled to the eductor outlet of each eductor of the plurality of eductors and to the at least one CO₂-lean gas outlet, and the capture solution tank is configured to collect the rich capture solution. The capture solution distribution line fluidly coupled to the capture solution inlet of each eductor of the plurality of eductors.

In an aspect combinable with the example implementation, the system includes a regeneration system fluidly coupled to the capture solution tank and the capture solution distribution line.

In another aspect combinable with any of the previous aspects, the capture solution tank is fluidly coupled to the regeneration system via a capture solution circulation pump.

In another aspect combinable with any of the previous aspects, the regeneration system includes at least one of a lime causticization system or a calciner.

In another aspect combinable with any of the previous aspects, the lime causticization system includes at least one of a pellet reactor or a slaker.

In another aspect combinable with any of the previous aspects, the calciner includes an electric calciner.

In another aspect combinable with any of the previous aspects, the regeneration system has a product conduit configured to provide a product of the regeneration system.

In another aspect combinable with any of the previous aspects, the plurality of eductors is positioned on a perimeter of the capture solution tank.

In another aspect combinable with any of the previous aspects, the at least one CO₂-lean gas outlet is fluidly coupled to each eductor outlet of the plurality of eductors.

In another aspect combinable with any of the previous aspects, the plurality of eductors is arranged circumferentially along the perimeter about the at least one CO₂-lean gas outlet.

In another aspect combinable with any of the previous aspects, the plurality of eductors is arranged in a plurality of rows of eductors.

In another aspect combinable with any of the previous aspects, the plurality of eductors is fluidly coupled to the at least one CO₂-lean gas outlet.

In another aspect combinable with any of the previous aspects, the plurality of eductors includes six eductors.

In another aspect combinable with any of the previous aspects, the at least one CO₂-lean gas outlet includes six CO₂-lean gas outlets, each of the six CO₂-lean gas outlets fluidly coupled to a respective one of the six eductors.

In another aspect combinable with any of the previous aspects, the system includes at least one mist eliminator fluidly coupled to the at least one CO₂-lean gas outlet.

In another aspect combinable with any of the previous aspects, the at least one mist eliminator includes a chevron-type mist eliminator.

In another aspect combinable with any of the previous aspects, the at least one mist eliminator is positioned upstream of the at least one fan.

In another aspect combinable with any of the previous aspects, the system includes at least one mixing chamber fluidly coupled to the eductor outlet of at least one eductor of the plurality of eductors.

In another aspect combinable with any of the previous aspects, the at least one mixing chamber includes a static mixer.

In another aspect combinable with any of the previous aspects, the system includes at least one packed bed absorption column fluidly coupled to the at least one CO₂-lean gas outlet.

In another aspect combinable with any of the previous aspects, the at least one packed bed absorption column is positioned upstream of the at least one fan.

In another aspect combinable with any of the previous aspects, the at least one packed bed absorption column includes a structured packing.

In another aspect combinable with any of the previous aspects, the system includes a rate-enhancing material coating on at least one of the plurality of eductors, the capture solution tank, or a wetted surface.

In another aspect combinable with any of the previous aspects, the plurality of eductors is operable to flow a lean capture solution that includes a rate-enhancing additive.

In another aspect combinable with any of the previous aspects, the rate-enhancing additive includes at least one of piperazine, carbonic anhydrase, or monoethanolamine.

In another aspect combinable with any of the previous aspects, the system includes an auxiliary unit or an intermediate system fluidly coupled to the capture solution tank.

In another aspect combinable with any of the previous aspects, the at least one CO₂-lean gas outlet is positioned to route the CO₂-lean gas away from the gas inlet of each eductor of the plurality of eductors.

In another example implementation, a method for removing carbon dioxide from a gas includes: flowing a lean capture solution into a capture solution inlet of an eductor to draw the gas into a gas inlet of the eductor according to the Venturi effect, reacting the gas with the lean capture solution to form a mixed fluid that includes a rich capture solution and a CO₂-lean gas, flowing the mixed fluid to a capture solution tank to collect the rich capture solution, and discharging the CO₂-lean gas of the mixed fluid.

In an aspect combinable with the example implementation, the method includes regenerating a first portion of the rich capture solution to form a regenerated capture solution.

In another aspect combinable with any of the previous aspects, the method includes combining a second portion of the rich capture solution with the regenerated capture solution to form the lean capture solution.

In another aspect combinable with any of the previous aspects, the method include, in an absorption column, mixing at least part of the regenerated capture solution and the CO₂-lean gas to capture carbon dioxide from the CO₂-lean gas and to form a rich regenerated capture solution and a CO₂-lean absorber gas, and discharging the CO₂-lean absorber gas.

In another aspect combinable with any of the previous aspects, the method includes reducing mist from the CO₂-lean absorber gas before discharging the CO₂-lean absorber gas.

In another aspect combinable with any of the previous aspects, regenerating the first portion of the rich capture solution includes flowing the first portion of the rich capture solution to at least one of a lime causticization system, a pellet reactor, a slaker, or a calciner.

In another aspect combinable with any of the previous aspects, regenerating the first portion of the rich capture solution includes flowing the first portion of the rich capture solution to an auxiliary unit or to an intermediate system.

In another aspect combinable with any of the previous aspects, regenerating the first portion of the rich capture solution includes forming the regenerated capture solution and a concentrated carbon stream.

6 In another aspect combinable with any of the previous aspects, the method includes releasing a CO₂-rich gas stream from the concentrated carbon stream; and compressing the CO₂-rich gas stream to form a product stream.

In another aspect combinable with any of the previous aspects, the lean capture solution includes a KOH molarity ranging from 1 molar to 6 molar.

In another aspect combinable with any of the previous aspects, the method includes flowing a make up capture solution into the capture solution tank.

In another aspect combinable with any of the previous aspects, the make up capture solution includes a KOH concentration ranging from 0.1 wt % to 50 wt %.

In another aspect combinable with any of the previous aspects, the method includes flowing a make up water stream into the capture solution tank.

In another aspect combinable with any of the previous aspects, the lean capture solution includes at least one of an amine, potassium hydroxide, sodium hydroxide, potassium carbonate, bicarbonate, sodium carbonate, or water.

In another aspect combinable with any of the previous aspects, the lean capture solution includes an NaOH molarity ranging from 1 molar to 6 molar.

In another aspect combinable with any of the previous aspects, the method includes reducing mist from the CO₂-lean gas before discharging the CO₂-lean gas.

In another aspect combinable with any of the previous aspects, the method includes, in a packed bed absorption column, mixing at least one of the lean capture solution and the rich capture solution with the CO₂-lean gas to capture carbon dioxide from the CO₂-lean gas.

In another aspect combinable with any of the previous aspects, the method includes flowing the gas through a pre-treatment unit prior to drawing the gas into the gas inlet of the eductor.

In another aspect combinable with any of the previous aspects, the method includes flowing a rate-enhancing additive through the eductor.

In another aspect combinable with any of the previous aspects, the rate-enhancing additive includes at least one of piperazine, carbonic anhydrase, or monoethanolamine.

In another aspect combinable with any of the previous aspects, flowing the rate-enhancing additive includes flowing the rate-enhancing additive into the capture solution tank.

In another aspect combinable with any of the previous aspects, flowing the rate-enhancing additive includes combining the rate-enhancing additive with the lean capture solution.

In another aspect combinable with any of the previous aspects, flowing the lean capture solution into the capture solution inlet of the eductor to draw the gas into the gas inlet of the eductor includes flowing the lean capture solution vertically downward and drawing the gas along a horizontal direction into the gas inlet.

### BRIEF DESCRIPTION OF THE DRAWINGS

FIG. 1 is a cross sectional view of an example gas-liquid contactor unit.

FIG. 2 is a cross sectional view of an example supplemented gas-liquid contactor unit.

FIG. 3 is a plan view of an example linear gas-liquid contactor system.

FIG. 4 is an isometric view of an example perimetric gas-liquid contactor system.

FIG. 5 is an isometric view of an example multi-row gas-liquid contactor system.

FIG. 6 is a block flow diagram illustrating an example integrated gas capture system including a gas-liquid contactor system fluidly coupled to a regeneration system.

FIG. 7 is a flowchart illustrating an example method for removing CO₂ from gas.

FIG. 8 is a schematic diagram of an example control system for a gas-liquid contactor system.

### DETAILED DESCRIPTION

The present disclosure describes a gas-liquid contactor system in which an eductor, also referred to as an ejector venturi scrubber, is used in conjunction with a fan to effectively remove carbon dioxide (CO₂) from a gas stream.

Eductor systems, also known as ejector venturi scrubbers, can be a useful type of gas-liquid contact system for applications where evaporative water losses are a concern, such as in arid, hot climates, or cold environments where low temperatures can lead to freezing of the liquid sorbent. Such gas-liquid contactor systems can be used as an alternative to gas-liquid contactor systems that are designed based on cooling towers or gas scrubbers. The use of an eductor system can have certain advantages such as safer operation, smaller footprint, and simplified maintenance.

The eductor draws in gas through a gas inlet by using a lean capture solution, such as a KOH/K₂CO₃ solution, as a motive liquid. In some aspects of the present disclosure, “lean” can mean that the capture solution has not yet absorbed the target gas species, or that the concentration of the target gas species in the capture solution is lower than it will become once the capture solution is exposed to the target gas species. The lean capture solution is pumped through a constricted section or throat of the eductor. The constriction causes the fluid pressure to decrease as the fluid velocity increases. Due to the Bernoulli effect, this creates a partial vacuum on the gas inlet of the eductor which draws in the gas. The high-pressure fluid passing through the throat forms numerous fine liquid droplets that provide turbulent mixing of the lean capture solution and the gas. This initial mixing zone is where the lean capture solution first reacts with impurities in the gas. For example, a capture solution comprising KOH would react with CO₂ in the gas as follows:

CO_{2(g)}+2KOH_{(aq)}→K₂CO_{3(aq)}+H₂O₍1) (Eq.1)

Capture solutions used in processes such as DAC and point source CO₂ capture can employ capture agents other than KOH. Capture solutions are selected for their performance and ability in capturing at least a portion of CO₂ when contacted with a gas comprising CO₂. For some applications, capture solutions comprising alkaline solutions are suitable, such as aqueous solutions comprising one or more of KOH (as shown in Eq. 1), NaOH, K₂CO₃, Na₂CO₃, NaHCO₃, and KHCO₃. For some applications, capture solutions comprising amine-based solvents or additives are suitable, such as aqueous solutions comprising one or more of monoethanolamine (MEA) and diethanolamine (DEA). Another example of a capture solution including an amine-based solvent is isophorone diamine (IPDA) which may form carbamic acid when contacted with CO₂ from the air. Another example of a capture solution includes amine salts.

Removal of at least a portion of CO₂ from the gas according to the above reaction (Eq. 1), or according to another reaction involving a different capture agent, produces a CO₂-lean gas and a rich capture solution. In some cases, the CO₂-lean gas may not be completely free of CO₂ but may have less CO₂ compared to the inlet gas. The CO₂-lean gas can be discharged through a fan positioned at the CO₂-lean gas outlet. The fan is used for modifying the ratio of capture solution to gas by controlling the gas velocity at the gas inlet of the eductor. The fan also may also reduce the energy required from the motive fluid to draw the gas into the eductor, as the fan can be a more efficient device for moving a gas than an eductor alone. In some cases, it can also be advantageous to flow the CO₂-lean gas through other elements such as a mist or drift eliminator or absorption column prior to discharging it from the system. In some cases, a portion of the rich capture solution can be sent to a regeneration system. Another portion of the rich capture solution can be circulated and combined with fresh or regenerated capture solution to form the lean capture solution.

Throughout the disclosure, the terms “ejector venturi scrubber,” “venturi flow device,” and “eductor” are used interchangeably to describe a component of the gas-liquid contactor system which employs the Venturi effect to draw a gas into the eductor component using a motive liquid. The eductor can also include a spray nozzle that aims the motive liquid at the constriction of the eductor.

Each of the configurations described herein can include intermediate processing steps or units that are not illustrated. There can be at least one intermediate unit between the gas-liquid contactor system and a regeneration system. For example, capture solution can flow into a holding tank prior flowing to a regeneration system. In another example, a filtration system can intervene the gas-liquid contactor system and the regeneration system. It can be beneficial to implement a rate-enhancing additive, in the gas-liquid contactor system to increase the rate of transfer of CO₂ from the gas to the aqueous solution. Rate-enhancing additives can include catalysts, promoters, solvents, or other types of additives. Examples of rate-enhancing additives can include, for example, carbonic anhydrase, piperazine, MEA, DEA, zinc triazacycles, zinc tetraazacycles, copper glycinates, hydroxopentaaminecobalt perchlorate, formaldehyde hydrate, saccharose, fructose, glucose, phenols, phenolates, glycerin, arsenite, vanadium pentoxide, hypochlorite, hypobromite, or other oxyanionic species. In some implementations, the filtration system can detain at least a portion of a rate-enhancing additive within the gas-liquid contactor system to prevent the rate-enhancing additive from denaturing or deteriorating in the regeneration system due to heat, pressure, shear, stress, or other process conditions that cause degradation to the promotor. Additionally, some auxiliary equipment and units or intermediate systems (e.g., tanks, filters, conveyors, mix tanks, separators, pumps) can be employed as part of the overall process. These auxiliary units can form intermediate systems and/or facilitate intermediate processing steps between the gas-liquid contactor system and regeneration system.

Each of the configurations described herein can be fluidly coupled to at least one other gas-liquid air contactor unit or gas-liquid air contactor system to form a modularized system such as a grid or a network. A modularized system enables capture of larger amounts of CO₂ from one or more sources. For instance, a network can include multiple gas-liquid contactor systems coupled to one or more one central processing facilities comprising at least one regeneration facility or train of processing systems. A regeneration facility can consist of multiple regeneration trains, each train including a complete set of equipment to process feedstock streams into the appropriate outlet product streams. In multiple train systems, one or more trains can be taken offline for maintenance without significant impact to the overall regeneration facility capacity. Varying the number of trains in operation can also be used to ramp capacity up or down, in cases where upstream capture facilities require a range of processing capacities.

Each of the configurations and methods described herein can include at least one mixed fluid stream that has a respective gas phase and liquid phase. Each of the mixed fluid streams can travel from an inlet to an outlet of an element and can comprise mostly liquid at the inlet but mostly gas at the outlet. The ratio of liquid to gas and composition of the mixed fluids depends on several factors including reaction rate, mass transfer, and process conditions. In some implementations, there can be more or less mixed fluid streams than depicted.

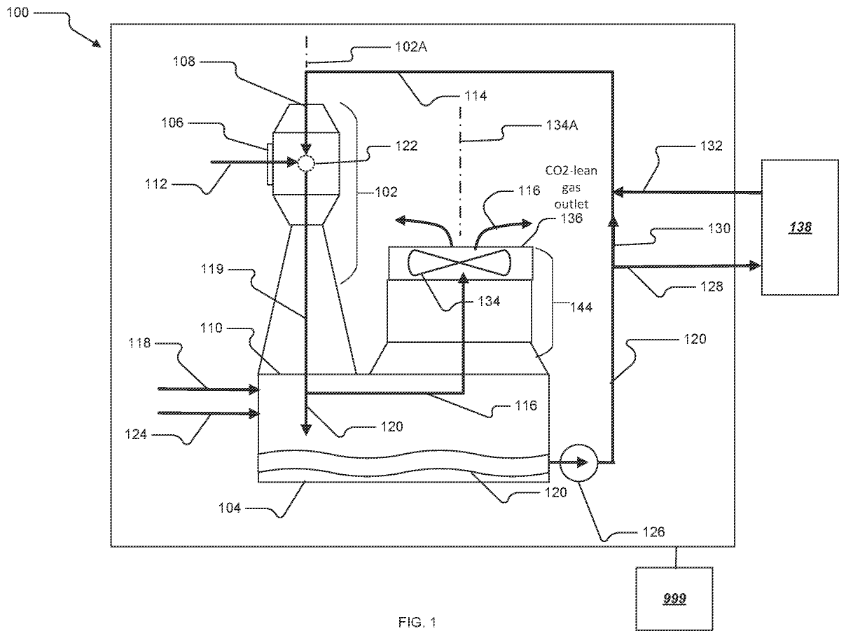

The process streams in the gas-liquid contactor systems, as well as process streams within any downstream processes with which the gas-liquid contactor systems are fluidly coupled, can be flowed using one or more flow control systems (e.g., control system 999 in FIGS. 1-6) implemented throughout the system. A flow control system can include one or more flow pumps, fans, blowers, or solids conveyors to move the process streams, one or more flow pipes through which the process streams are flowed and one or more valves to regulate the flow of streams through the pipes. Each of the configurations described herein can include at least one variable frequency drive (VFD) coupled to a respective pump that is capable of controlling at least one liquid flow rate. In some implementations, liquid flow rates are controlled by at least one flow control valve.

In some embodiments, a flow control system can be operated manually. For example, an operator can set a flow rate for each pump or transfer device and set valve open or close positions to regulate the flow of the process streams through the pipes in the flow control system. Once the operator has set the flow rates and the valve open or close positions for all flow control systems distributed across the system, the flow control system can flow the streams under constant flow conditions, for example, constant volumetric rate or other flow conditions. To change the flow conditions, the operator can manually operate the flow control system, for example, by changing the pump flow rate or the valve open or close position.

In some embodiments, a flow control system can be operated automatically. For example, the flow control system can be connected to a computer or control system (e.g., control system 999) to operate the flow control system. The control system can include a computer-readable medium storing instructions (such as flow control instructions and other instructions) executable by one or more processors to perform operations (such as flow control operations). An operator can set the flow rates and the valve open or close positions for all flow control systems distributed across the facility using the control system. In such embodiments, the operator can manually change the flow conditions by providing inputs through the control system. Also, in such embodiments, the control system can automatically (that is, without manual intervention) control one or more of the flow control systems, for example, using feedback systems connected to the control system. For example, a sensor (such as a pressure sensor, temperature sensor or other sensor) can be connected to a pipe through which a process stream flows. The sensor can monitor and provide a flow condition (such as a pressure, temperature, or other flow condition) of the process stream to the control system. In response to the flow condition exceeding a threshold (such as a threshold pressure value, a threshold temperature value, or other threshold value), the control system can automatically perform operations. For example, if the pressure or temperature in the pipe exceeds the threshold pressure value or the threshold temperature value, respectively, the control system can provide a signal to the pump to decrease a flow rate, a signal to open a valve to relieve the pressure, a signal to shut down process stream flow, or other signals.

FIG. 1 is a view of an example gas-liquid contactor unit 100. Gas-liquid contactor unit 100 includes an eductor 102 mounted on a capture solution tank 104. Eductor 102 can be fixed or movably attached to capture solution tank 104. Eductor 102 includes a gas inlet 106, a capture solution inlet 108, and an eductor outlet 110. Gas inlet 106 is operable to receive a gas 112 comprising CO₂. In cases where eductor 102 is movably attached, gas inlet 106 of eductor 102 can rotate or be oriented towards dominant wind flows, thereby reducing energy needed to draw large volumes of gas. In some cases, eductor 102 can have multiple gas inlets 106 wherein some gas inlets 106 face different angles than other gas inlets 106, and some gas inlets 106 can be optionally blinded, closed or covered if not facing the dominant wind direction.

In some implementations, gas 112 can be an atmospheric gas having a dilute CO₂ concentration, for example in the range of approximately 300-10,000 ppm. In other implementations, gas 112 can be a flue gas, or exhaust gas from an industrial or point source having a higher range of CO₂ concentration. The CO₂ concentration of gas 112 can depend on the type of point source. For example, the point source can include 10-15 v/v % CO₂ in the case of a coal-fired power plant. In the case of gas 112 originating from a point source, gas inlet 106 can be coupled to additional piping that carries gas 112 from the point source. Gas 112 may carry contaminants, such as NOx and SOx, in addition to CO₂. For example, gas 112 can be a flue gas or exhaust gas including NOx and SOx, which may adversely impact the CO₂ capture mechanism in eductor 102. In such cases, gas 112 can be pre-treated in a pre-treatment unit to remove these contaminants before flowing into gas inlet 106.

In other cases, gas 112 may originate from a dilute source such as atmospheric air and may carry moisture, dust, insects, or particulates based on local weather and geographic conditions. In such cases, gas inlet 106 can have additional elements, such as a mesh, to keep the dust, insects, and particulates from entering the eductor 102.

Capture solution inlet 108 is operable to receive a lean capture solution 114 that, in one implementation, is an aqueous mixture comprising KOH and/or K₂CO₃. For example, lean capture solution 114 can comprise a KOH molarity ranging from less than 1 molar to about 6 molar. In other implementations, lean capture solution 114 comprises another hydroxide-carbonate mixture such as NaOH and Na₂CO₃. For example, lean capture solution 114 can comprise an NaOH molarity ranging from less than 1 molar to about 6 molar. In other implementations, lean capture solution comprises a different aqueous mixture comprising a bicarbonate/carbonate or an aqueous amine mixture. Lean capture solution 114 is employed as the motive fluid to draw gas 112 into gas inlet 106. A reaction of lean capture solution 114 with CO₂ in gas 112 occurs at least partially in an initial mixing zone 122 within eductor 102. Initial mixing zone 122 is configured to achieve turbulent mixing to facilitate the reaction of lean capture solution 114 with CO₂ in eductor 102. In some implementations, a spray nozzle can be employed to aim lean capture solution 114 at the constricted section of eductor 102 to promote turbulent mixing in initial mixing zone 122. The reaction forms a mixed fluid 119 that has a gas phase and a liquid phase.

Referring to FIG. 1, lean capture solution 114 employed as the motive fluid of eductor 102 flows in a downward direction to draw gas 112 into gas inlet 106 along a transverse (e.g. substantially or primarily horizontally) direction.

The reaction of lean capture solution 114 with CO₂ progresses in eductor 102 such that both the hydroxide concentration [OH⁻] in the liquid phase of mixed fluid 119 and the CO₂ concentration in the gas phase of mixed fluid 119 decreases while the carbonate concentration [CO₃²⁻] in the liquid phase of mixed fluid 119 increases. Eductor 102 has an eductor outlet 110 that is operable to discharge mixed fluid 119 into capture solution tank 104.

The liquid phase of mixed fluid 119 can be collected in capture solution tank 104. In some cases, the liquid phase of mixed fluid 119 includes rich capture solution 120 and at least a portion of lean capture solution 114 that did not react. Rich capture solution 120 has a higher concentration of carbon-containing species, such as carbonates, compared to lean capture solution 114. Capture solution tank 104 is fluidly and mechanically coupled to a vent stack 144. The gas phase of mixed fluid 119 is drawn out of capture solution tank 104 by a fan 134 housed in vent stack 144. In some cases, the gas phase of mixed fluid 119 includes a CO₂-lean gas 116 and at least a portion of gas 112 that did not react. CO₂-lean gas 116 has a lower concentration of CO₂ than gas 112 and is a product stream yielded by gas-liquid contactor unit 100. Referring to FIG. 1, capture solution tank 104 is disposed beneath eductor 102 and fan 134. In some implementations, and referring to FIG. 1, fan 134, vent stack 144 and eductor 102 all overlie capture solution tank 104.

In some cases, the ratio of carbonate concentration [CO₃²⁻] to hydroxide concentration [OH⁻] may be higher in rich capture solution 120 than in lean capture solution 114. For example, the [CO₃²⁻] to [OH⁻] ratio in lean capture solution 114 may be less than about 0.4 and the [CO₃²⁻] to [OH⁻] ratio in rich capture solution 120 may be more than about 0.5.

In some cases, the gas-liquid contactor unit 100 is relatively closed to the surrounding environment. The combination of relatively-closed eductor 102 and vent stack 144 helps to prevent or reduce evaporative losses from gas-liquid contactor unit 100. Despite these features, in some implementations, it may be desirable to make-up for evaporative losses in gas-liquid contactor unit 100 that may occur over time. In some cases, rich capture solution 120 can include a make up capture solution stream 118, a make up water stream 124, or a combination of both, which are supplied to capture solution tank 104. Make up water stream 124 can be supplied at a rate that compensates for evaporative losses.

In some implementations, make up capture solution 118 has a KOH concentration ranging from 0.1 wt % to about 50 wt %. Make up capture solution 118 can compensate for dilution from ingested water or capture solution losses that may occur. In the illustrated implementation, rich capture solution 120 is pumped out of capture solution tank 104 via a capture solution circulation pump 126 and can be split into a first portion of rich capture solution 128 and a second portion of rich capture solution 130. In some implementations, capture solution circulation pump 126 has a discharge pressure in a range of about 20 psig to about 120 psig. In some implementations, capture solution circulation pump 126 has a discharge pressure in a range of about 80 psig to about 100 psig. Splitting rich capture solution 120 into first portion of rich capture solution 128 and second portion of rich capture solution 130 can be achieved by a distribution header, manifold or other suitable flow diversion device. For example, the distribution header can have an inlet and at least two outlets. The inlet of the distribution header can be coupled to a pipe flowing rich capture solution 120 to the distribution header, and the distribution header can split rich capture solution 120 into first portion of rich capture solution 128 and second portion of rich capture solution 130. The distribution header can discharge the first portion of rich capture solution 128 through a first outlet and the second portion of rich capture solution 130 through a second outlet. The outlets of the distribution header can each be coupled to a respective pipe and a respective outlet valve.

A first portion of rich capture solution 128 can be transferred to a regeneration system 138 where CO₂ is concentrated and released. For example, a capture solution comprising KOH and K₂CO₃ may lead to the following reactions in the regeneration system 138:

K₂CO₃ _{_{(ag)}}+Ca(OH)₂_{₍ₛ₎}→2KOH_{aq}+CaCO₃_{₍ₛ₎} (Eq. 2)

CaO₍ₛ₎+H₂O₍ₗ₎→Ca(OH)₂_{₍ₛ₎} (Eq. 3)

CaCO₃_{₍ₛ₎}→CaO₍ₛ₎+CO₂_{_{(g)}} (Eq. 4)

In some applications, potassium (K) in the reactions of Eq. 1 through Eq. 4 can be replaced by sodium (Na). For example, gas-liquid contactor can employ NaOH instead of KOH as the capture agent in the reaction of Eq. 1.

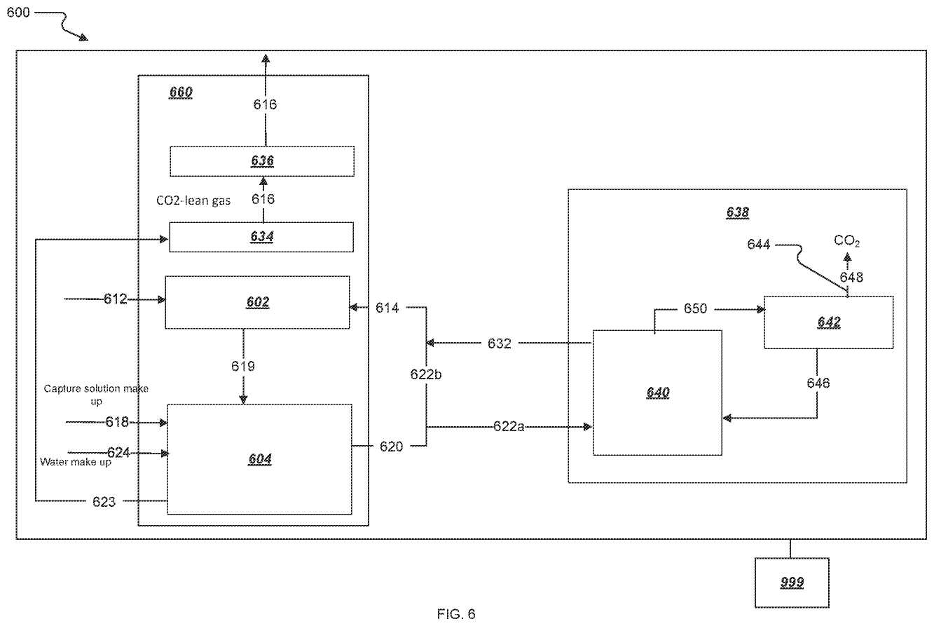

The reactions of Eq. 2, Eq. 3, and Eq. 4 can occur in a regeneration system 138 comprising a lime causticization system, such as lime causticization system 640 of FIG. 6. The lime causticization system can include one or more reactor tanks in which reactions of Eq. 2 and Eq. 3 occur. In some of these implementations, the reactor tanks can include continuously stirred tank reactors. In some implementations, the lime causticization system includes a pellet reactor in which the reaction of Eq. 2 occurs and a separate slaker in which the reaction of Eq. 3 occurs. The regeneration system 138 can also include a calciner in which the reaction of Eq. 4 occurs. In one implementation, the calciner is an electric calciner. In other implementations, the calciner can be a circulating fluid bed calciner, bubbling bed calciner, rotary calciner, or flash calciner. The regeneration system 138 produces a regenerated capture solution 132, which combines with second portion of rich capture solution 130 to form lean capture solution 114. Capture solution inlet 108 of eductor 102 is configured to receive lean capture solution 114. In one implementation, the regeneration system 138 comprises an electrochemical processing system that is operable to generate carbon products. For example, the regeneration system 138 can include elements similar to those described in U.S. Pat. Nos. 8,871,008, 8,119,091, and U.S. Patent Application Publication No. 2022/0362707 A1, each of which is incorporated herein by reference, such as membrane separation process units, gas stripping units, filtration units and gas compression and clean up units. Membrane separation units are used to separate dissolved target species, such as CO₂, from buffer species in aqueous streams and may include one or more components such as nanofiltration units, chromotagraphy columns, and the like. Driving forces for the membrane separation processes may include, for example, electricity, pressure, temperature, concentration differences, or salinity gradients. The one or more components in the membrane separation unit can be the same or different. In some implementations, the membrane separation unit includes an ion exchange membrane (e.g., a monovalent anion exchange membrane), which can be used in the unit for a process such as, for example, electrodialysis. Other components of the membrane separation unit can be used for various other processes such as, for example, reverse osmosis, ultrafiltration, microfiltration, nanofiltration, diffusion dialysis, dialysis, Donnan dialysis, piezodialysis, pervaporation, membrane distillation, and ion chromatography. In some cases, a gas stripping unit includes a membrane distillation unit.

In some implementations, capture solution tank 104 includes two outlets that are each fluidly coupled to a respective pump. The first outlet discharges a first portion of rich capture solution 120 to a first pump that flows the first portion of rich capture solution 120 to regeneration system 138. The second outlet discharges a second portion of rich capture solution 120 which is combined with regenerated solution 132 flowing from regeneration system 138 to form lean capture solution 114. Lean capture solution 114 is then flowed to eductor 102 via a second pump.

Fan 134 is positioned at a CO₂-lean gas outlet 136 of vent stack 144 that is fluidly coupled to capture solution tank 104. Fan 134 can be an induced draft fan, in which the rotation of fan 134 draws CO₂-lean gas 116 from the upper portion of capture solution tank 104 through CO₂-lean gas outlet 136. CO₂-lean gas 116 is discharged through CO₂-lean gas outlet 136. It can be beneficial for CO₂-lean gas outlet 136 to be positioned to discharge or to route CO₂-lean gas 116 away from the gas inlet 106 of eductor 102 and from the gas inlets of any adjacent eductors (e.g., in multiple-eductor implementations described below). For example, CO₂-lean gas outlet 136 can be positioned to route CO₂-lean gas 116 towards the ground, thereby avoiding CO₂-lean gas 116 from entering the gas inlets of any adjacent gas-liquid contactor units. In one implementation, fan 134 is sized for an outlet velocity in a range of about 1 ft./s to up to about 25 ft./s. In some implementations, fan 134 is sized for an outlet velocity of less than about 10 ft./s.

Referring to FIG. 1, eductor 102 and vent stack 144 are upright bodies. Eductor 102 defines an upright eductor axis 102A. Eductor axis 102A is parallel to the vertical in FIG. 1. Eductor axis 102A is parallel to a vertical distance measured between capture solution inlet 108 and eductor outlet 110. Vent stack 144 extends along a direction parallel to a fan axis 134A of fan 134. Fan axis 134A is parallel to eductor axis 102A. In the implementation of FIG. 1, fan axis 134A and eductor axis 102A are horizontally spaced apart. In other implementations, fan axis 134A and eductor axis 102A may be collinear.

In some applications, it can be beneficial for eductor 102 to be as large as practically possible. For example, some catalog eductors can have a height of up to 36 feet and an air inlet diameter of up to 96 inches, but larger custom units can be designed and fabricated. In some implementations, gas-liquid contactor unit 100 can be at least partially constructed of a caustic-compatible material such as thermoplastics, thermoset resins, stainless steel, or a combination thereof. Some examples of suitable thermoplastics include polyvinyl chloride (PVC), chlorinated polyvinyl chloride (CPVC), polytetrafluoroethylene (PTFE). An example of a suitable thermoset resin is brominated bisphenol-A based vinyl ester.

In some cases, at least one of lean capture solution 114, rich capture solution 120, make up capture solution 118, and regenerated capture solution 132 can comprise a rate-enhancing additive that is capable of increasing the amount of CO₂ captured. Some examples of rate-enhancing additives include catalysts, promoters, or solvents such as piperazine, carbonic anhydrase, MEA, and DEA. In some cases, the rate-enhancing additive can move freely in the capture solution within gas-liquid contactor unit 100. In some cases, the rate-enhancing additive can be immobilized in capsules that move freely in the capture solution within gas-liquid contactor unit 100. In cases where the rate-enhancing additive is moving freely, the rate-enhancing additive can be detained within gas-liquid contactor unit 100 and impeded from flowing to regeneration system 138 by a barrier or a filtration system. In some cases, it can be advantageous to coat a surface of an element of gas-liquid contactor unit 100 with a rate-enhancing material that includes a rate-enhancing additive, for example a promoter or a catalyst, that is stabilized on a solid support by suitable immobilization methods. Gas-liquid contactor unit 100 can have a number of wetted surfaces coated with a rate-enhancing material. For example, eductor 102 and capture solution tank 104 can each have a wetted surface that is coated with a rate-enhancing material. In particular, inner walls, components, and surfaces wetted by capture solution within gas-liquid contactor unit 100 can be coated with a rate-enhancing material. In some applications, a combination of a freely moving rate-enhancing additive in the capture solution and a rate-enhancing material coated on surfaces within the gas-liquid contactor can be employed to improve CO₂ uptake. In some implementations the type and amount of rate-enhancing additive used can depend on capture solution properties, for example compositions, the presence of bicarbonate or amines, temperature or pH.

In some implementations gas-liquid contactor unit 100 is communicably coupled to and controlled with a control system 999.

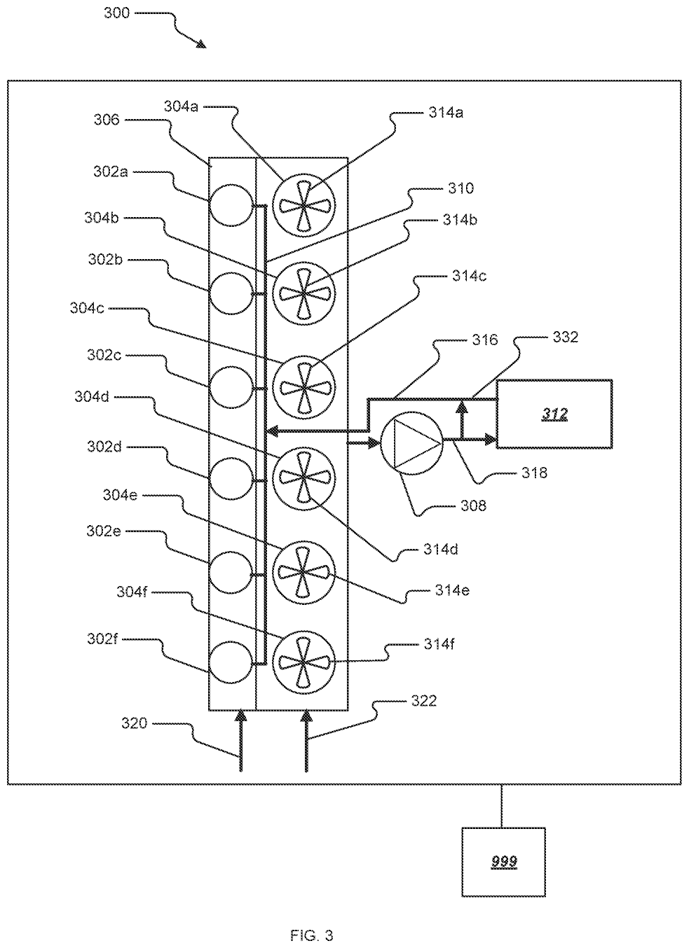

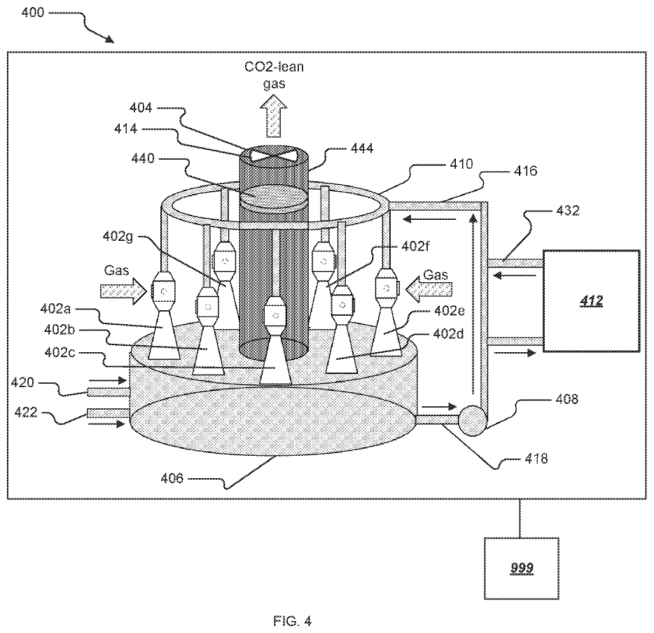

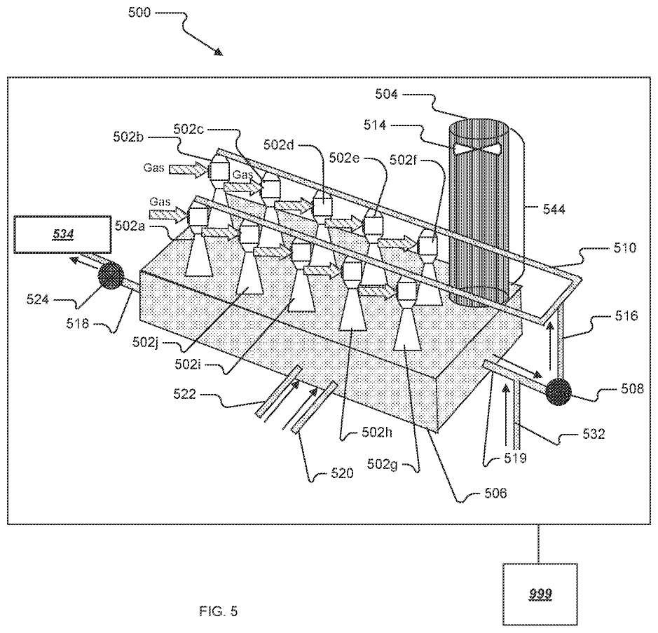

Elements of gas-liquid contactor unit 100 can form a module for a modular gas-liquid contactor system, such as system 300 of FIG. 3, system 400 of FIG. 4, and system 500 of FIG. 5.

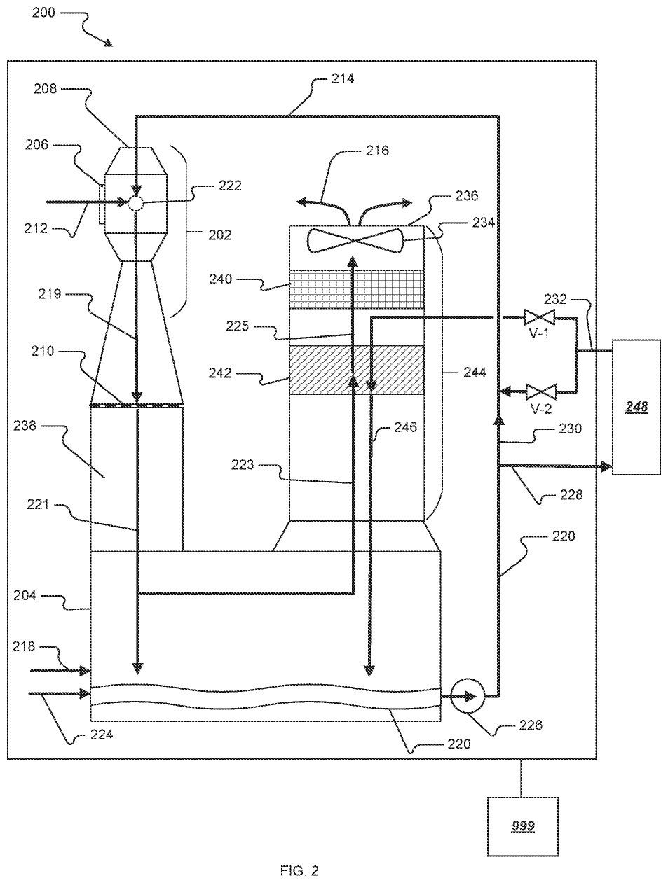

FIG. 2 is a cross sectional view of an example supplemented gas-liquid contactor unit 200. Supplemented gas-liquid contactor unit 200 includes some of the same elements as gas-liquid contactor unit 100 of FIG. 1. For example, elements 202 to 236 of FIG. 2 can operate or be configured in the same or similar manner as elements 102 to 136 of FIG. 1. For brevity, some of the previously described functions and implementations that are applicable to both gas-liquid contactor unit 100 and supplemented gas-liquid contactor unit 200 will be omitted from the description of FIG. 2 below. The description of gas-liquid contactor unit 100 provided herein, and of all features and advantages associated with gas-liquid contactor unit 100, applies mutatis mutandis to gas-liquid contactor unit 200.

As illustrated in FIG. 2, supplemented gas-liquid contactor unit 200 includes several elements, such as a mixing chamber 238, a mist eliminator 240, and a packed bed absorption column 242. In implementations, each of mixing chamber 238, mist eliminator 240, and packed bed absorption column 242 may be used in supplemented gas-liquid contactor unit 200 independently or in combination with one another. For example, supplemented gas-liquid contactor unit 200 can include mixing chamber 238 and mist eliminator 240 but exclude packed bed absorption column 242. In another example, supplemented gas-liquid contactor unit 200 can include mist eliminator 240 but exclude mixing chamber 238 and packed bed absorption column 242.

Supplemented gas-liquid contactor unit 200 includes an eductor 202 fluidly and mechanically coupled to a capture solution tank 204. Eductor 202 can be fixed or movably attached to capture solution tank 204. In cases where eductor 202 is movably attached to capture solution tank 204, eductor 202 can rotate or be oriented towards dominant wind flows, thereby reducing energy needed to draw large volumes of gas. Eductor 202 includes a gas inlet 206, a capture solution inlet 208, and an eductor outlet 210. Gas inlet 206 is operable to receive a gas 212 comprising CO₂. In some cases, eductor 202 can have multiple gas inlets 206 wherein some gas inlets 206 face different angles than other gas inlets 206, and some gas inlets 206 can be optionally blinded, closed or covered if not facing the dominant wind direction.

Capture solution inlet 208 is operable to receive a lean capture solution 214 that, in one implementation, is an aqueous mixture comprising KOH and K₂CO₃. A reaction of lean capture solution 214 with CO₂ in gas 212 occurs at least partially in an initial mixing zone 222 within eductor 202. Initial mixing zone 222 is configured to achieve turbulent mixing to facilitate the reaction of lean capture solution 214 with CO₂ in gas 212 within eductor 202. In some implementations, a spray nozzle can be employed to aim lean capture solution 214 at the constricted section of eductor 202 to promote turbulent mixing in initial mixing zone 222. The reaction in initial mixing zone 222 forms a first mixed fluid 219 that has a gas phase and a liquid phase.

The reaction of lean capture solution 214 with CO₂ progresses in eductor 202 such that the hydroxide concentration [OH⁻] in the liquid phase of first mixed fluid 219 and the CO₂ concentration in the gas phase of first mixed fluid 219 decreases while the carbonate concentration [CO₃²⁻] in the liquid phase of first mixed fluid 219 increases. Eductor 202 has an eductor outlet 210 that is operable to discharge first mixed fluid 219 into a mixing chamber 238.

Eductor outlet 210 is fluidly coupled to mixing chamber 238. In one implementation, mixing chamber 238 is a static mixer configured to promote turbulent mixing and shearing of gas-liquid mixtures by employing textured surfaces and/or static mixing elements to achieve high tortuosity and high mass transfer. Non-limiting examples of textured surfaces and/or static mixing elements include, or are present on, baffles and vanes. Mixing chamber 238 can enable rapid dissolution and attainment of gas-liquid equilibrium. The reaction of lean capture solution 214 and CO₂ in first mixed fluid 219 progresses further in mixing chamber 238 to form a second mixed fluid 221 that has a gas phase and a liquid phase. Referring to FIG. 2, the mixing chamber 238 is positioned vertically between eductor outlet 210 and capture solution tank 204.

The reaction progresses in mixing chamber 238 such that both the [OH⁻] in the liquid phase of second mixed fluid 221 and the CO₂ concentration in the gas phase of second mixed fluid 221 decreases while the [CO₃²⁻] in the liquid phase of second mixed fluid 221 increases. Second mixed fluid 221 is discharged from mixing chamber 238 into capture solution tank 204.

Mixing chamber 238 is fluidly coupled to capture solution tank 204. Capture solution tank 204 collects the liquid phases of the mixed fluids. In some cases, capture solution tank 204 is operable to receive a make up capture solution stream 218, a make up water stream 224, or a combination of both. These streams are added to liquid in capture solution tank 204 to form rich capture solution 220. Make up capture solution 218 can compensate for dilution from ingested water or capture solution losses that may occur. In the illustrated implementation, a rich regenerated capture solution 246 is received by capture solution tank 204 and combined with liquid phases of the mixed fluids to form rich capture solution 220. Rich capture solution 220 is pumped out of capture solution tank 204 via a capture solution circulation pump 226 and is split into a first portion of rich capture solution 228 and a second portion of rich capture solution 230. Splitting rich capture solution 220 into first portion of rich capture solution 228 and second portion of rich capture solution 230 can be achieved by a distribution header, a manifold or other suitable flow diversion device. For example, a distribution header for distributing rich capture solution 220 can have an inlet for receiving the rich capture solution 220 and at least two outlets for distributing the split portions 228, 230 of the rich capture solution. The inlet of the distribution header can be coupled to a pipe flowing rich capture solution 220 to the distribution header, and the distribution header can split rich capture solution 220 into first portion of rich capture solution 228 and second portion of rich capture solution 230. The distribution header can then discharge first portion of rich capture solution 228 through a first outlet and second portion of rich capture solution 230 through a second outlet. The outlets of the distribution header can each be coupled to a respective pipe and a respective outlet valve. After flowing out the respective outlets of the distribution header, the first portion of rich capture solution 228 can be transferred to a regeneration system 248 and the second portion of rich capture solution 230 can be combined with a lean regenerated capture solution 232 formed in the regeneration system 248. Other configurations of fluid flow, division and distribution for rich capture solution 220 are possible.

In some implementations, capture solution tank 204 includes two outlets that are each fluidly coupled to a respective pump. For example, the capture solution tank 204 can include a first outlet that discharges a first portion of rich capture solution to a first pump that flows the first portion of rich capture solution 220 to regeneration system 248 and a second outlet that discharges a second portion of rich capture solution 220, which is combined with lean regenerated solution 232 flowing from regeneration system 248 to form lean capture solution 214. Lean capture solution 214 is then flowed to eductor 202 via a second pump.

The liquid phase of second mixed fluid 221 can be collected in capture solution tank 204 and combined with rich capture solution 220. The reaction of lean capture solution 214 with CO₂ progresses further within capture solution tank 204 to form a third mixed fluid 223 that has a gas phase and a liquid phase.

The reaction progresses in capture solution tank 204 such that both the [OH⁻] in the liquid phase of third mixed fluid 223 and the CO₂ concentration in the gas phase of third mixed fluid 223 decreases while the [CO₃²⁻] in the liquid phase of third mixed fluid 223 increases. The liquid phase of third mixed fluid 223 is collected in capture solution tank 204. The gas phase of third mixed fluid 223 is drawn out of capture solution tank 204 into a vent stack 244 by a fan 234.

Capture solution tank 204 is mechanically and fluidly coupled to vent stack 244. In some implementations, vent stack 244 can house at least one of a packed bed absorption column 242 positioned upstream of a mist eliminator 240 and fan 234. Each element housed in vent stack 244 can be directly or indirectly fluidly coupled to CO₂-lean gas outlet 236. In some implementations, vent stack 244 houses packed bed absorption column 242 and fan 234. In other implementations, vent stack 244 houses mist eliminator 240 and fan 234. In some implementations, packed bed absorption column 242 is positioned upstream of mist eliminator 240 and fan 234. In some implementations, and referring to FIG. 2, mist eliminator 240, packed bed absorption column 242, fan 234 and CO₂-lean gas outlet 236 are all present in supplemented gas-liquid contactor unit 200, and are stacked one above the other. Referring to FIG. 2, packed bed absorption column 242, mist eliminator 240, fan 234 and CO₂-lean gas outlet 236 are spaced apart vertically, and arranged sequentially from packed bed absorption column 242 at the lowest vertical position to CO₂-lean gas outlet 236 at the highest vertical position.

In some implementations, lean regenerated capture solution 232 is introduced to packed bed absorption column 242. Packed bed absorption column 242 includes packing material that is shaped to provide a large surface area for capture solution to contact the third mixed fluid stream 223, thereby increasing the amount of CO₂ captured. In one implementation, packed bed absorption column 242 comprises structured packing (e.g., corrugated sheets). In some implementations, packed bed absorption column 242 comprises a zone of loose or random packing (e.g., Raschig rings) that are contained within packed bed absorption column 242. Lean regenerated capture solution 232 is introduced to packed bed absorption column 242 from the regeneration system 248. A countercurrent flow of the gas phase of third mixed fluid 223 and lean regenerated capture solution 232 in packed bed absorption column 242 enables further capture of CO₂ from third mixed fluid 223 that was not captured in eductor 202, mixing chamber 238, and capture solution tank 204. For example, lean regenerated capture solution 232 flows through the packed bed absorption column 242 towards capture solution tank 204 while the third mixed fluid 223 flows through packed bed absorption column 242 towards CO₂-lean gas outlet 236 and reacts with lean regenerated capture solution 232 in packed bed absorption column 242. The reaction forms a fourth mixed fluid 225 that has a gas phase (e.g. CO₂-lean gas from packed bed absorption column 242) and a liquid phase, and rich regenerated capture solution 246.

The reaction progresses in packed bed absorption column 242 such that both the [OH⁻] in the liquid phase of fourth mixed fluid 225 and the CO₂ concentration in the gas phase of fourth mixed fluid 225 is less than that of the third mixed fluid 223, while the [CO₃²⁻] in the liquid phase of fourth mixed fluid 225 is greater than that of the third mixed fluid 223. The [CO₃²⁻] in rich regenerated capture solution 246 is greater than that of lean regenerated capture solution 232. The fourth mixed fluid 225 is drawn from packed bed absorption column 242 to mist eliminator 240 by fan 234 and rich regenerated capture solution 246 is collected in capture solution tank 204 and combined with the liquid phases of mixed fluids to form rich capture solution 220.

In one implementation, supplemented gas-liquid contactor unit 200 can be employed to carry out chemistry of the Benfield process wherein K₂CO₃ is used to remove acid gases, including CO₂. In such an implementation, supplemented gas-liquid contactor unit 200 and the regeneration system 248 can be configured to employ chemistry of the Benfield process according to reactions of Eq. 5 below.

K₂CO_{3(aq)}+CO_{2(g)}+H₂O₍ₗ₎⇄2KHCO₃_{₍ₗ₎} (Eq. 5)

For example, in the chemistry of the Benfield process, supplemented gas-liquid contactor unit 200 can be coupled to a regeneration system 248 capable of recovering the absorbed CO₂, for example by steam stripping, and regenerating the K₂CO₃ to return to packed bed absorption column 242. The regeneration system 248 can be configured to process a bicarbonate solution.

Packed bed absorption column 242 is fluidly coupled to mist eliminator 240. In some implementations, mist eliminator 240 is positioned upstream of fan 234 to reduce the number of liquid droplets entrained in fourth mixed fluid 225 before the gas phase of fourth mixed fluid 225 is discharged from supplemented gas-liquid contactor unit 200 as CO₂-lean gas 216. Mist eliminator 240 can be a chevron-type mist eliminator wherein liquid droplets entrained in fourth mixed fluid 225 adhere to an angled surface of the mist eliminator 240 while the gas phase of fourth mixed fluid 225 passes through mist eliminator 240 as CO₂-lean gas 216. In some implementations, mist eliminator 240 is sized for a face velocity of from about 1 ft./s to up to about 15 ft./s. In some implementations, mist eliminator 240 is sized for a face velocity of less than about 10 ft./s.

Mist eliminator 240 is fluidly coupled to fan 234. Fan 234 can be an induced draft fan that draws CO₂-lean gas 216 from mist eliminator 240. In one implementation, fan 234 is sized to produce an outlet velocity in a range of about 1 ft./s to up to about 25 ft./s. In some implementations, fan 234 is sized to produce an outlet velocity of less than about 10 ft./s. In some implementations, the fan 234 is sized to match the mist eliminator face velocity. In some implementations, the CO₂-lean gas 216 has a lower concentration of CO₂ than gas 212 and/or the gas phase of at least one or first mixed fluid 219, second mixed fluid 221, third mixed fluid 223, and fourth mixed fluid 225. CO₂-lean gas 216 is discharged through a CO₂-lean gas outlet 236 as a product stream of supplemented gas-liquid contactor unit 200. It can be beneficial for CO₂-lean gas outlet 236 to be positioned to discharge or to route CO₂-lean gas 216 away from the gas inlet 206 of eductor 202 and from the gas inlets of any adjacent eductors. For example, CO₂-lean gas outlet 236 can be positioned to route CO₂-lean gas 216 towards the ground, thereby avoiding CO₂-lean gas 216 from entering the gas inlets of any adjacent gas-liquid contactor units.

In some implementations the lean regenerated capture solution 232 can be provided via a valve or connection to the second portion of rich capture solution 230, or via a valve or inlet directly to the top of the packed bed absorption column 242, or a combination of both. For example, in the illustrated implementation, supplemented gas-liquid contactor unit 200 includes valves that control the flow of lean regenerated capture solution 232 from a regeneration system 248. In some implementations, valve V-1 controls a flow of lean regenerated capture solution 232 to a packed bed absorption column 242. In some implementations, valve V-2 controls a flow of lean regenerated capture solution 232 to be combined with a second portion of rich capture solution 230. The flow rate of lean regenerated capture solution 232 (via the position of at least one of the valve V-1 and valve V-2) can determine the composition of lean capture solution 214 that is returned to capture solution inlet 208 of eductor 202.

For example, if first valve V-1 is open and second valve V-2 is closed, lean capture solution 214 will include a lower hydroxide concentration [OH⁻] and a higher carbonate concentration [CO3 2-] than if first valve V-1 is closed and second valve V-2 is open. For instance, if first valve V-1 is open and second valve V-2 is closed, rich regenerated capture solution 246 combines with the liquid phases of mixed fluids in a capture solution tank 204 to form rich capture solution 220 that splits into lean capture solution 214 and a first portion of rich capture solution 228. Lean regenerated capture solution 232 flows through packed bed absorption column 242 and reacts with CO₂ in third mixed fluid 223 to form rich regenerated capture solution 246. The reaction of CO₂ with lean regenerated capture solution 232 decreases the hydroxide concentration [OH⁻] and increases the carbonate concentration [CO₃²⁻] in rich regenerated capture solution 246. Rich regenerated capture solution 246 then combines with rich capture solution 220 and returns to eductor 202 as lean capture solution 214. In this case, the hydroxide concentration [OH⁻] and the carbonate concentration [CO₃²⁻] of lean capture solution 214 are changed by an upstream reaction with CO₂ as a result of lean regenerated capture solution 232 flowing through V-1.

As another example, if first valve V-1 is closed and second valve V-2 is open, lean regenerated capture solution 232 combines with a second portion of rich capture solution 230 to form lean capture solution 214. Lean regenerated capture solution 232 does not react with CO₂ before combining with second portion of rich capture solution 230 and returning to eductor 202 as lean capture solution 214. In this case, the hydroxide concentration [OH⁻] and the carbonate concentration [CO₃²⁻] of lean capture solution 214 are not impacted by a flow of lean regenerated capture solution 232 through V-1 over packed bed absorption column 242 since valve V-1 is closed and, thus, no lean regenerated capture solution 232 is flowing through V-1 into the packed bed absorption column 242.

In some implementations, the respective liquid phase of first mixed fluid 219, second mixed fluid 221, third mixed fluid 223, and fourth mixed fluid 225 can each include at least a portion of lean capture solution 214 that did not react. In some cases, the respective gas phase of first mixed fluid 219, second mixed fluid 221, third mixed fluid 223, and fourth mixed fluid 225 can each include at least a portion of CO₂ in gas 112 that did not react.

Although each of the mixed fluid streams are ordinally named, the ordinal naming merely indicates the location or position of the mixed fluid within the unit and/or system and does not necessitate the order by which the mixed fluid is formed. Thus, each of the mixed fluid streams can comprise at least a portion of any of the preceding mixed fluid streams. For example, the third mixed fluid 223 can comprise at least a portion of the first mixed fluid 219 and does not necessarily require an intervening second mixed fluid 221 to be formed.

In some cases, the regeneration system 248 processes first portion of rich capture solution 228 to increase the concentration of carbon-containing species, and then the carbon is released as a concentrated product. In one implementation, the regeneration system 248 comprises an electrochemical processing system that is operable to generate carbon products. For example, the regeneration system 248 can include elements of U.S. Pat. Nos. 8,871,008, 8,119,091 and U.S. Patent Application Publication No. 2022/0362707 A1, wherein membrane separation units are used to separate dissolved target species, such as CO₂, from buffer species in aqueous streams.

In some applications, it can be beneficial for eductor 202 to be as large as practically possible. For example, some catalog eductors can have a height of up to 36 feet and an air inlet diameter of up to 96 inches, but larger custom units can be designed and fabricated. In some implementations, supplemented gas-liquid contactor unit 200 can be at least partially constructed of a caustic-compatible material such as thermoplastics, thermoset resins, stainless steel, or a combination thereof. Some examples of suitable thermoplastics include polyvinyl chloride (PVC), chlorinated polyvinyl chloride (CPVC), polytetrafluoroethylene (PTFE). An example of a suitable thermoset resin is brominated bisphenol-A based vinyl ester.

In some cases, at least one of lean capture solution 214, rich capture solution 220, make up capture solution 218, lean regenerated capture solution 232, and rich regenerated capture solution 246 includes a rate-enhancing additive that can enhance CO₂ capture rate, such as piperazine, carbonic anhydrase, MEA, and DEA. The rate-enhancing additive can move freely in the capture solution within supplemented gas-liquid contactor unit 200. In some cases, the rate-enhancing additive can be immobilized in capsules that move freely in the capture solution within supplemented gas-liquid contactor unit 200. In implementations where the rate-enhancing additive is moving freely, the rate-enhancing additive can be contained within supplemented gas-liquid contactor unit 200 and impeded from flowing to a regeneration system 248 by a barrier or a filtration system. In some cases, it can be advantageous for supplemented gas-liquid contactor unit 200 to have a number of wetted surfaces coated with a rate-enhancing material. The rate-enhancing material can include a rate-enhancing additive that is stabilized on a solid support by immobilization methods. For example, eductor 202, capture solution tank 204, mixing chamber 238, packed bed absorption column 242, and vent stack 244 can each have a wetted surface that is coated with a rate-enhancing material. In particular, the inner walls of supplemented gas-liquid contactor unit 200 can be coated with a rate-enhancing material. In some applications, a combination of a freely moving rate-enhancing additive in the capture solution and a rate-enhancing material coated on surfaces within the gas-liquid contactor can be employed to improve CO₂ uptake.

In some implementations, supplemented gas-liquid contactor unit 200 can is coupled to and controlled with a control system 999.

Elements of supplemented gas-liquid contactor unit 200 can form a module for a modular gas-liquid contactor system such as linear gas-liquid contactor system 300 of FIG. 3, perimetric gas-liquid contactor system 400 of FIG. 4, and multi-row gas-liquid contactor system 500 of FIG. 5.

FIG. 3 is a plan view of an example linear gas-liquid contactor system 300. Linear gas-liquid contactor system 300 includes a set of eductors 302a, 302b, 302c, 302d, 302e, 302f (collectively and individually referred to as eductor 302) fluidly coupled to a set of CO₂-lean gas outlets 304a, 304b, 304c, 304d, 304e, 304f (collectively and individually 304). Eductors 302 and CO₂-lean gas outlets 304 are mechanically and fluidly coupled to a capture solution tank 306. Eductors 302 can be fixed or movably attached to a capture solution tank 306. Eductors 302 that are movably attached can rotate or be oriented towards dominant wind flows, thereby reducing energy needed to pass large volumes of air into the gas inlets. CO₂-lean gas outlets 304 are each coupled to a respective fan 314a, 314b, 314c, 314d, 314e, 314f (collectively and individually referred to as fan 314).

Linear gas-liquid contactor system 300 can comprise at least some of the elements of gas-liquid contactor unit 100 of FIG. 1 or supplemented gas-liquid contactor unit 200 of FIG. 2. Thus the description herein of gas-liquid contactor unit 100 and of supplemented gas-liquid contactor unit 200, and of all features and advantages associated with gas-liquid contactor unit 100 and with supplemented gas-liquid contactor unit 200, applies mutatis mutandis to eductors 302 and to linear gas-liquid contactor system 300. Eductors 302 can each include a gas inlet operable to receive a gas comprising CO₂, a capture solution inlet operable to receive a lean capture solution 316 from a capture solution distribution line 310, and a mixing zone configured to achieve turbulent mixing to facilitate the reaction of the gas and lean capture solution 316. In some implementations, a spray nozzle can be employed to aim lean capture solution 316 at the constricted section of eductors 302 to promote turbulent mixing in the initial mixing zones. Turbulent mixing enables CO₂ from the gas to be absorbed to form a mixed fluid that has a gas phase and liquid phase. For example, a CO₂ absorption reaction that can occur in the initial mixing zones of eductors 302 is described in Eq. 1 above.

Reacting lean capture solution 316 and CO₂ in the gas forms a mixed fluid having a gas phase and a liquid phase. As the reaction progresses throughout linear gas-liquid contactor system 300, the hydroxide concentration [OH⁻] in the liquid phase of mixed fluid and the CO₂ concentration in the gas phase of the mixed fluid decreases while the carbonate concentration [CO₃²⁻] in the liquid phase of the mixed fluid increases. In some cases, the ratio of carbonate concentration [CO₃²⁻] to hydroxide concentration [OH⁻] can be higher in rich capture solution 318 than in lean capture solution 316. For example, if the [CO₃²⁻] to [OH⁻] ratio in lean capture solution 316 less than about 0.4, then the [CO₃²⁻] to [OH⁻] ratio in rich capture solution 318 can be more than about 0.5.

Eductors 302 are fluidly coupled to capture solution tank 306. Rich capture solution 318 flows from eductors 302 to capture solution tank 306. In one implementation, intervening mixing chambers (e.g., static mixers) are fluidly coupled to outlets of eductors 302 and to capture solution tank 306, as depicted in supplemented gas-liquid contactor unit 200 of FIG. 2. Mixing chambers or static mixers fluidly coupled to outlets of eductors 302 promote turbulent mixing and shearing of gas-liquid mixtures. In such an implementation, further mixing of CO₂ with lean capture solution 316 can further the reaction to form the mixed fluid. The reaction progresses in the mixing chamber such that both the [OH⁻] in the liquid phase of the mixed fluid and the CO₂ concentration in the gas phase of the mixed fluid decreases while the [CO₃²⁻] in the liquid phase of the mixed fluid increases. In some cases, at least some of eductors 302 can have multiple gas inlets facing various angles and are operable to be blinded, closed or covered if not facing the dominant wind direction.

A capture solution circulation pump 308 is fluidly coupled to capture solution tank 306. Capture solution circulation pump 308 pumps rich capture solution 318 out of capture solution tank 306. A first portion of rich capture solution 318 is pumped to a regeneration system 312 and a second portion of rich capture solution 318 is circulated back to eductors 302 via capture solution distribution line 310. In some implementations, the second portion of rich capture solution 318 is combined with the regenerated capture solution 332 to form a lean capture solution stream 316. In some implementations, the flow rate of lean capture solution 316 in capture solution distribution line 310 can be varied based on a target amount of CO₂ captured. In one implementation, the first portion of rich capture solution 318 can be larger than the second portion of rich capture solution 318. In some implementations, capture solution tank 306 includes two outlets that are each fluidly coupled to a respective pump. For example, the first outlet can discharge a first portion of rich capture solution 318 to a first pump that flows the first portion of rich capture solution 318 to regeneration system 312, and the second outlet can discharge a second portion of rich capture solution 318 to be combined with regenerated lean solution 332 flowing from regeneration system 312 to form lean capture solution 316. Lean capture solution 316 can then be flowed to eductors 302 via a second pump.

Regeneration system 312 can comprise a lime causticization system, such as lime causticization system 640 of FIG. 6, to form the regenerated capture solution 332. In one implementation, regeneration system 312 comprises an electrochemical processing system that is operable to generate carbon products. For example, regeneration system 638 can comprise the same or similar elements as those described in U.S. Pat. Nos. 8,871,008, 8,119,091 and U.S. Patent Application Publication No. 2022/0362707 A1, wherein membrane separation units are used to separate dissolved target species, such as CO₂, from buffer species in aqueous streams.

The liquid phase of the mixed fluid can be collected in capture solution tank 306 and combined with rich capture solution 318. The reaction of lean capture solution 316 with CO₂ in the gas entering the gas inlets of eductors 302 can continue within capture solution tank 306 to further the reaction to form the mixed fluid.

The reaction progresses in capture solution tank 306 such that both the [OH⁻] in the liquid phase of the mixed fluid and the CO₂ concentration in the gas phase of the mixed fluid decreases while the [CO₃²⁻] in the liquid phase of the mixed fluid increases. The liquid phase of the mixed fluid is collected in capture solution tank 306 as it forms. The gas phase of the mixed fluid is drawn out of capture solution tank 306 into one or more vent stacks of the eductors 302 by fans 314.

In some implementations, fans 314 are induced draft fans. Linear gas-liquid contactor system 300 can comprise multiple vent stacks, wherein each vent stack comprises a fan 314. In some cases, at least one vent stack can include other elements as described in reference to vent stack 244 of FIG. 2. For example, vent stacks in linear gas-liquid contactor system 300 can include one or more of respective packed bed absorption columns, and/or respective mist eliminators positioned upstream of fans 314.

In some implementations, regenerated capture solution 332 can flow over the packed bed absorption columns to absorb at least a portion of any remaining CO₂ in the mixed fluid that was not absorbed in eductors 302 or capture solution tank 306 in a counterflow reaction. The packed bed absorption columns can include structured packing or loose (e.g., random) packing.

In one implementation, linear gas-liquid contactor system 300 can be employed to carry out chemistry of the Benfield process wherein K₂CO₃ is used to remove acid gases, including CO₂. In such an implementation, downstream units (e.g., a regeneration system including a steam stripper) are also configured to employ chemistry of the Benfield process according to reactions of Eq. 5.

The system 300 can include mist eliminators positioned upstream of fans 314 (e.g., similar to mist eliminator 240 of FIG. 2). The mist eliminators of linear gas-liquid contactor system 300 can be chevron-type mist eliminators that adhere to liquid droplets entrained in the mixed fluid. The gas phase of the mixed fluid can be drawn by fans 314 and discharged as CO₂-lean gas (e.g., a product stream) through CO₂-lean gas outlets 304. It can be beneficial for CO₂-lean gas outlet 304 to be positioned to discharge or to route CO₂-lean gas away from the gas inlets of eductors 302 and from the gas inlets of any adjacent eductors. For example, CO₂-lean gas outlet 304 can be positioned to route CO₂-lean gas towards the ground, thereby avoiding CO₂-lean gas from entering the gas inlets of any adjacent gas-liquid contactor units.

Eductors 302 can be linearly aligned with one another on capture solution tank 306. Similarly, CO₂-lean gas outlets 304 can be linearly aligned with one another on capture solution tank 306. Each eductor 302 can be positioned across from and fluidly coupled to a respective CO₂-lean gas outlet 304. For example, eductor 302a is fluidly coupled to and positioned across from CO₂-lean gas outlet 304a. In an alternate implementation, eductors 302 can be staggered such that only certain eductors are aligned (e.g., eductor 302a is aligned with eductor 302c but not eductor 302b). Although FIG. 3 illustrates a linear arrangement, implementations can exist in which the linear alignment of eductors 302 and/or CO₂-lean gas outlets 304 is imperfect. In some implementations, linear gas-liquid contactor system 300 can include six eductors 302 as depicted in FIG. 3. However, other implementations are possible wherein linear gas-liquid contactor system 300 comprises more or less than six eductors 302.

Eductors 302 can also be fluidly coupled to one another via capture solution distribution line 310. This can be useful if one or more eductor(s) 302 are inactive, as capture solution distribution line 310 can include one or more valves, of either manual or automatic control, to cause lean capture solution 316 to bypass the inactive eductor(s) 302. For example, a valve along capture solution distribution line 310 and fluidly coupled to a particular inactive eductor 302 can be closed to prevent lean capture solution 316 from entering the inactive eductor 302. Capture solution tank 306 includes inlets that are operable to receive a make up water stream 320, a make up capture solution stream 322, or a combination of both, in order to maintain a particular lean capture solution concentration (e.g., KOH molarity ranging from less than 1 molar to about 6 molar or NaOH molarity ranging from less than 1 molar to about 6 molar) or to adjust for evaporative losses. Make up capture solution 322 can compensate for dilution from ingested water or capture solution losses that may occur. In some implementations, an example of which is provided in FIG. 3, linear gas-liquid contactor system 300 has a single capture solution tank 306 positioned beneath the outlets of all eductors 302. In such an implementation, capture solution tank 306 is common to all eductors 302, such that rich capture solution 318 from all eductors 302 mixes within capture solution tank 306. In alternate implementations, linear gas-liquid contactor system 300 has multiple capture solution tanks 306, where at least one capture solution tank 306 is fluidly isolated from at least another capture solution tank 306.

In some cases, at least one of lean capture solution 316, rich capture solution 318, and make up capture solution 322 can comprise a rate-enhancing additive that can enhance CO₂ capture rate, such as piperazine, carbonic anhydrase, MEA, and DEA. The rate-enhancing additive can move freely in the capture solution within linear gas-liquid contactor system 300. The rate-enhancing additive can be injected upstream of capture solution circulation pump 308 or downstream of stream 332. For example, the rate-enhancing additive can be injected into capture solution tank 306 and combined with rich capture solution in capture solution tank 306. In another example, the rate-enhancing additive can be injected into the capture solution inlets of eductors 302 and combined with lean capture solution in eductors 302. In another example, the rate-enhancing additive can be injected into capture solution distribution line 310. In some cases, the rate-enhancing additive can be immobilized in capsules that move freely in the capture solution within linear gas-liquid contactor system 300. In implementations where the rate-enhancing additive is moving freely, the rate-enhancing additive can be contained within linear gas-liquid contactor system 300 and impeded from flowing to a regeneration system 312 by a barrier or a filtration system. In some cases, it can be advantageous for linear gas-liquid contactor system 300 to have a number of wetted surfaces coated with a rate-enhancing material. The rate-enhancing material can include a rate-enhancing additive, for example a catalyst or a promoter, that is stabilized on a solid support by immobilization methods. For example, eductors 302 and capture solution tank 306 can each have a wetted surface that is coated with a rate-enhancing material. In particular, the inner walls and components of linear gas-liquid contactor system 300 can be coated with a rate-enhancing additive. In some applications, a combination of a freely moving rate-enhancing additive in the capture solution and a rate-enhancing material coated on surfaces within the gas-liquid contactor can be employed to improve CO₂ uptake.

In some applications, it can be beneficial for eductor 302 to be as large as practically possible. For example, some catalog eductors can have a height of up to 36 feet and an air inlet diameter of up to 96 inches, but larger custom units can be designed and fabricated. In some implementations, linear gas-liquid contactor system 300 can be at least partially constructed of a caustic-compatible material such as thermoplastics, thermoset resins, stainless steel, or a combination thereof. Some examples of suitable thermoplastics include polyvinyl chloride (PVC), chlorinated polyvinyl chloride (CPVC), polytetrafluoroethylene (PTFE). An example of a suitable thermoset resin is brominated bisphenol-A based vinyl ester.

In some implementations, linear gas-liquid contactor system 300 can be communicably coupled to and controlled with a control system 999.

FIG. 4 is an isometric view of an example perimetric gas-liquid contactor system 400. Perimetric gas-liquid contactor system 400 includes some of the same or similar elements as linear gas-liquid contactor system 300 of FIG. 3. For brevity, some previously described functions and implementations that are applicable to both linear gas-liquid contactor system 300 and perimetric gas-liquid contactor system 400 will be omitted from the description of FIG. 4 below.

Perimetric gas-liquid contactor system 400 includes a set of eductors 402a, 402b, 402c, 402d, 402e, 402f, 402g (collectively and individually referred to as eductor 402) fluidly coupled to a CO₂-lean gas outlet 404. Eductors 402 and a vent stack 444 are mechanically and fluidly coupled to capture solution tank 406. Eductors 402 can be fixed or movably attached to capture solution tank 406. Eductors 402 that are movably attached can rotate or be oriented towards dominant wind flows, thereby reducing energy needed to pass large volumes of air into the gas inlets. Vent stack 444 houses a CO₂-lean gas outlet 404 that is fluidly coupled to a fan 414 and a mist eliminator 440.

Perimetric gas-liquid contactor system 400 can comprise at least some of the elements of gas-liquid contactor unit 100 of FIG. 1 or supplemented gas-liquid contactor unit 200 of FIG. 2. Thus the description herein of gas-liquid contactor unit 100 and of supplemented gas-liquid contactor unit 200, and of all features and advantages associated with gas-liquid contactor unit 100 and with supplemented gas-liquid contactor unit 200, applies mutatis mutandis to eductors 402 and to perimetric gas-liquid contactor system 400. Eductors 402 can each include a gas inlet operable to receive a gas comprising CO₂, a capture solution inlet operable to receive a lean capture solution from a capture solution distribution line 410, and a mixing zone wherein turbulent mixing of the gas and the lean capture solution occurs. Turbulent mixing enables CO₂ from the gas to be absorbed to form a rich capture solution and a CO₂-lean gas including a lower concentration of CO₂ than the gas received by eductors 402. In some cases, at least some of eductors 402 can have multiple gas inlets facing various angles and are operable to be blinded, closed or covered if not facing the dominant wind direction.

Reacting lean capture solution 416 and CO₂ in the gas forms a mixed fluid having a gas phase and a liquid phase. As the reaction progresses throughout perimetric gas-liquid contactor system 400, the hydroxide concentration [OH⁻] in the liquid phase of mixed fluid and the CO₂ concentration in the gas phase of the mixed fluid decreases while the carbonate concentration [CO₃²⁻] in the liquid phase of the mixed fluid increases.

Eductors 402 are fluidly coupled to capture solution tank 406. The rich capture solution flows from eductors 402 to capture solution tank 406. In one implementation, intervening mixing chambers (e.g., static mixers) are fluidly coupled to eductors 402 and capture solution tank 406, such as mixing chamber 238 in supplemented gas-liquid contactor unit 200 of FIG. 2. In such an implementation, further mixing of CO₂ with any unreacted lean capture solution 416 can further the reaction to form the mixed fluid. The reaction progresses in the mixing chamber such that both the [OH⁻] in the liquid phase of the mixed fluid and the CO₂ concentration in the gas phase of the mixed fluid decreases while the [CO₃²⁻] in the liquid phase of the mixed fluid increases.

In some cases, the ratio of carbonate concentration [CO₃^{2'1}] to hydroxide concentration [OH⁻] can be higher in rich capture solution 418 than in lean capture solution 416. For example, if the [CO₃²⁻] to [OH⁻] ratio in lean capture solution 416 less than about 0.4, then the [CO₃²⁻] to [OH⁻] ratio in rich capture solution 418 can be more than about 0.5.

Capture solution circulation pump 408 is fluidly coupled to capture solution tank 406. Capture solution circulation pump 408 pumps rich capture solution 418 out of capture solution tank 406. A first portion of rich capture solution 418 is pumped to a regeneration system 412. A second portion of rich capture solution 418 is combined with a regenerated capture solution 432 to form lean capture solution 416, which is circulated to eductors 402 via capture solution distribution line 410. In some implementations, the flow rate of lean capture solution 416 in capture solution distribution line 410 can be varied based on a target amount of CO₂ captured. In one implementation, the first portion of rich capture solution 418, which is pumped to regeneration system 412, is larger than the second portion of rich capture solution 418, which is combined with the regenerated capture solution 432 to form lean capture solution 416.

In some implementations, capture solution tank 406 includes two outlets that are each fluidly coupled to a respective pump. For example, a first outlet can discharge a first portion of rich capture solution 418 to a first pump that flows the first portion of rich capture solution 418 to a regeneration system 412, and a second outlet can discharge a second portion of rich capture solution 418, which is then combined with regenerated lean solution 432 flowing from regeneration system 412 to form lean capture solution 416. Lean capture solution 416 is then flowed to eductors 402 via a second pump.

Regeneration system 412 can comprise a lime causticization system, such as causticization system 640 of FIG. 6, to form regenerated capture solution 432. In one implementation, regeneration system 412 comprises an electrochemical processing system that is operable to generate carbon products. For example, regeneration system 412 can comprise one or more of the elements described in U.S. Pat. Nos. 8,871,008, 8,119,091 and U.S. Patent Application Publication No. 2022/0362707 A1, such as membrane separation units that are used to separate dissolved target species, such as CO₂, from buffer species in aqueous streams.

The liquid phase of the mixed fluid can be collected in capture solution tank 406 and combined with rich capture solution 418. The reaction of lean capture solution 416 with CO₂ in the gas entering the gas inlets of eductors 402 can continue within capture solution tank 406 to further the reaction to form the mixed fluid.

The reaction progresses in capture solution tank 406 such that both the [OH⁻] in the liquid phase of the mixed fluid and the CO₂ concentration in the gas phase of the mixed fluid decreases while the [CO₃^{2'1}] in the liquid phase of the mixed fluid increases. The liquid phase of the mixed fluid is collected in capture solution tank 406 as it forms. The gas phase of the mixed fluid is drawn out of capture solution tank 406 into one or more vent stacks by a fan 414.

In some implementations, fan 414 is an induced draft fan. Capture solution tank 406 is mechanically coupled to a vent stack 444, which comprises some of the same elements as vent stack 244 of FIG. 2. In the illustrated implementation, vent stack 444 houses mist eliminator 440 upstream of fan 414. Mist eliminator 440 can be a chevron-type mist eliminator that adheres liquid droplets entrained in the mixed fluid. Mist eliminator 440 is an optional feature of vent stack 444, in that other implementations of the vent stack 444 are free of mist eliminator 440. The gas phase of the mixed fluid can be drawn upwards by fan 414 and discharged as CO₂-lean gas (e.g., a product stream) through CO₂-lean gas outlet 404. It can be beneficial for CO₂-lean gas outlet 404 to be positioned to discharge or to route CO₂-lean gas away from the gas inlets of eductors 402 and from the gas inlets of any adjacent gas-liquid contactor systems. For example, CO₂-lean gas outlet 404 can be positioned to route CO₂-lean gas towards the ground, thereby avoiding CO₂-lean gas from entering the gas inlets of any adjacent gas-liquid contactor units.

In one implementation, vent stack 444 houses a packed bed absorption column positioned upstream of fan 414, similar to packed bed absorption column 242 of supplemented gas-liquid contactor unit 200. The packed bed absorption column can include structured packing or loose (random) packing and can have the same features as packed bed absorption column 242 of FIG. 2. In some implementations, rather than being combined into lean capture solution 416, the regenerated capture solution 432 can instead be directed to flow over the packed bed absorption column to absorb residual CO₂ in the mixed fluid that was not absorbed in eductors 402 or upstream elements, such as mixing chambers. In one implementation, vent stack 444 can include an air cooler that is operable to receive and discharge refrigerant. The air cooler can be positioned upstream of mist eliminator 440 to lower the temperature of the mixed fluid, enabling mist eliminator 440 to remove more liquid droplets entrained in the mixed fluid.

Eductors 402 are positioned at the perimeter of capture solution tank 406 and are fluidly coupled to CO₂-lean gas outlet 404 via capture solution tank 406. Referring to FIG. 4, eductors 402 are spaced apart circumferentially from each other, and are arranged circumferentially about vent stack 444. Vent stack 444 is positioned in the center of the circumferential arrangement of eductors 402. Capture solution distribution line 410 is shaped like a ring for distributing lean capture solution 416 to eductors 402. Other arrangements of eductors 402 are possible (see, for example, FIGS. 3 and 5). Capture solution tank 406 is illustrated as cylindrical, having a circular cross section. In other implementations, capture solution tank 406 can be other shapes and eductors 402 can be positioned at the perimeter. For example, capture solution tank 406 can have a rectangular, elliptical, or polygonal cross section, and eductors 402 can be positioned near one or more edges of capture solution tank 406. In one implementation, capture solution tank 406 can have a varying top surface (e.g., a conical top surface wherein vent stack 444 is raised at a higher elevation than eductors 402). Although FIG. 4 illustrates one vent stack 444 and seven eductors 402, it is possible for perimetric gas-liquid contactor system 400 to comprise multiple vent stacks 444 and/or a different number of eductors 402. For example, perimetric gas-liquid contactor system 400 can comprise two vent stacks 444 at the center of capture solution tank 406, surrounded by eight eductors 402 positioned at the perimeter. In some implementations, an example of which is provided in FIG. 4, perimetric gas-liquid contactor system 400 has a single capture solution tank 406 positioned beneath the outlets of all eductors 402. In such an implementation, capture solution tank 406 is common to all eductors 402, such that rich capture solution 418 from all eductors 402 mixes within capture solution tank 406. In alternate implementations, perimetric gas-liquid contactor system 400 has multiple capture solution tanks 406, where at least one capture solution tank 406 is fluidly isolated from at least another capture solution tank 406.

Eductors 402 are fluidly coupled to one another via capture solution distribution line 410. This can be useful if one or more eductor(s) 402 are inactive, as capture solution distribution line 410 can include one or more valves, of either manual or automatic control, to allow lean capture solution 416 to bypass the inactive eductor(s) 402. For example, a valve fluidly coupling an inactive eductor 402 to the capture solution distribution line 410 can be closed to prevent lean capture solution 416 from being provided to the inactive eductor 402.

Capture solution tank 406 includes inlets that are operable to receive a make up water stream 420, a make up capture solution stream 422, or a combination of both, in order to maintain a particular lean capture solution 416 concentration or to adjust for evaporative losses. Make up capture solution 422 can compensate for dilution from ingested water or capture solution losses that may occur. Perimetric gas-liquid contactor system 400 can be at least partially constructed of a caustic-compatible material such as thermoplastics, thermoset resins, stainless steel, or a combination thereof. Some examples of suitable thermoplastics include polyvinyl chloride (PVC), chlorinated polyvinyl chloride (CPVC), polytetrafluoroethylene (PTFE). An example of a suitable thermoset resin is brominated bisphenol-A based vinyl ester.

In some cases, at least one of lean capture solution 416, rich capture solution 418, and make up capture solution 422 can comprise a rate-enhancing additive that can enhance CO₂ capture rate, such as piperazine, carbonic anhydrase, MEA, and DEA. The rate-enhancing additive can move freely in the capture solution within perimetric gas-liquid contactor system 400. In some cases, the rate-enhancing additive can be immobilized in capsules that move freely in the capture solution within perimetric gas-liquid contactor system 400. The rate-enhancing additive can be injected upstream of capture solution circulation pump 408 or downstream of regenerated capture solution 432. For example, the rate-enhancing additive can be injected into capture solution tank 406 and combined with rich capture solution in capture solution tank 406. In another example, the rate-enhancing additive can be injected into the capture solution inlets of eductors 402 and combined with lean capture solution in eductors 402. In another example, the rate-enhancing additive can be injected into capture solution distribution line 410. In implementations where the rate-enhancing additive is moving freely, the rate-enhancing additive can be contained within perimetric gas-liquid contactor system 400 and impeded from flowing to a regeneration system 412 by a barrier or a filtration system. In some cases, it can be advantageous for perimetric gas-liquid contactor system 400 to have a number of wetted surfaces coated with a rate-enhancing material. The rate-enhancing material can include a rate-enhancing additive, for example a catalyst or a promoter, that is stabilized on a solid support by immobilization methods. For example, eductors 402, capture solution tank 406, and vent stack 444 can each have a wetted surface that is coated with a rate-enhancing material. In particular, the inner walls and components of perimetric gas-liquid contactor system 400 can be coated with a rate-enhancing material. In some applications, a combination of a freely moving rate-enhancing additive in the capture solution and a rate-enhancing material coated on surfaces within the gas-liquid contactor can be employed to improve CO₂ uptake.

In some implementations, perimetric gas-liquid contactor system 400 can be communicably coupled to and controlled with a control system 999.

FIG. 5 is an isometric view of an example multi-row gas-liquid contactor system 500. Multi-row gas-liquid contactor system 500 includes some of the same or similar elements as perimetric gas-liquid contactor system 400 of FIG. 4 and as linear gas-liquid contactor system 300 of FIG. 3. For brevity, some previously described functions and implementations that are applicable to linear gas-liquid contactor system 300 of FIG. 3, perimetric gas-liquid contactor system 400 and multi-row gas-liquid contactor system 500 will be omitted from the description of FIG. 5 below.

Multi-row gas-liquid contactor system 500 includes a set of eductors 502a, 502b, 502c, 502d, 502e, 502f, 502g, 502h, 502i 502j (collectively and individually referred to as eductor 502) fluidly coupled to a CO₂-lean gas outlet 504. In the illustrated implementation, a first eductor row includes eductors 502a and 502b, a second eductor row includes eductors 502c and 502j, a third eductor row includes eductors 502d and 502i, a fourth eductor row includes eductors 502e and 502h, and a fifth eductor row includes eductors 502f and 502g. Eductors 502 and a vent stack 544 are mechanically and fluidly coupled to capture solution tank 506. Vent stack 544 houses a fan 514 fluidly coupled to a CO₂-lean gas outlet 504. Eductors 502 can be fixed or movably attached to capture solution tank 506. Eductors 502 that are movably attached to the capture solution tank 506 can rotate or be oriented towards dominant wind flows, thereby reducing energy needed to pass large volumes of air into the gas inlets. In some cases, at least some of eductors 502 have multiple gas inlets facing various angles and are operable to be blinded, closed or covered if not facing the dominant wind direction.

Multi-row gas-liquid contactor system 500 can comprise at least some of the elements of gas-liquid contactor unit 100 of FIG. 1 or supplemented gas-liquid contactor unit 200 of FIG. 2. Thus the description herein of gas-liquid contactor unit 100 and of supplemented gas-liquid contactor unit 200, and of all features and advantages associated with gas-liquid contactor unit 100 and with supplemented gas-liquid contactor unit 200, applies mutatis mutandis to eductors 502 and to multi-row gas-liquid contactor system 500. Eductors 502 can each include a gas inlet operable to receive a gas comprising CO₂, a capture solution inlet operable to receive a lean capture solution 516 from a capture solution distribution line 510, and a mixing zone wherein turbulent mixing of the gas and lean capture solution 516 occurs. Turbulent mixing allows for CO₂ from the gas to be absorbed to form mixed fluid that has a gas phase and liquid phase.

Reacting lean capture solution 516 and CO₂ in the gas forms a mixed fluid having a gas phase and a liquid phase. As the reaction progresses throughout multi-row gas-liquid contactor system 500, the hydroxide concentration [OH⁻] in the liquid phase of mixed fluid and the CO₂ concentration in the gas phase of the mixed fluid decreases while the carbonate concentration [CO₃²⁻] in the liquid phase of the mixed fluid increases. In some cases, the ratio of carbonate concentration [CO₃²⁻] to hydroxide concentration [OH⁻] can be higher in first portion of rich capture solution 518 and second portion of rich capture solution 519 than in lean capture solution 516. For example, if the [CO₃²⁻] to [OH⁻] ratio in lean capture solution less than about 0.4, then the [CO₃²⁻] to [OH⁻] ratio in rich capture solution can be more than about 0.5.

Eductors 502 are fluidly coupled to a capture solution tank 506. The mixed fluid flows from eductors 502 to capture solution tank 506. In one implementation, intervening mixing chambers (e.g., static mixers) are fluidly coupled to eductors 502 and capture solution tank 506, as depicted in supplemented gas-liquid contactor unit 200 of FIG. 2. In such an implementation, further mixing of CO₂ with any unreacted lean capture solution can further the reaction to form the mixed fluid. The reaction progresses in the mixing chamber(s) such that both the [OH^{'1}] in the liquid phase of the mixed fluid and the CO₂ concentration in the gas phase of the mixed fluid decreases while the [CO₃²⁻] in the liquid phase of the mixed fluid increases. In some cases, at least some of eductors 502 can have multiple gas inlets facing various angles and are operable to be blinded, closed or covered if not facing the dominant wind direction.

In the illustrated implementation, capture solution tank 506 includes a first outlet for a first portion of rich capture solution 518 and a second outlet for a second portion of rich capture solution 519. Second portion of rich capture solution 519 and first portion of rich capture solution 518 may be similar in chemical composition but different in flow rate, temperature, and/or pressure. First portion of rich capture solution 518 is pumped to a regeneration system 534 via a rich capture solution pump 524. In some implementations, regeneration system 534 can include a lime causticization system and a calciner, such as regeneration system 638 of FIG. 6. In some implementations, regeneration system 534 can include an electrochemical processing system. Second portion of rich capture solution 519 can be combined with a regenerated capture solution 532 to form a lean capture solution 516 that is circulated back to eductors 502 via circulation pump 508 and capture solution distribution line 510.

In other implementations, capture solution tank 506 includes only one outlet for rich capture solution. For example, the rich capture solution can exit a single outlet in the capture solution tank, be pumped using a circulation pump, and then split into a first stream that is pumped to the regeneration system 534 and a second stream that is combined with regenerated capture solution 532 to form lean capture solution 516.

The liquid phase of the mixed fluid can be collected in capture solution tank 506 and combined with first portion of rich capture solution 518 and second portion of rich capture solution 519. The reaction of lean capture solution 516 with CO₂ in the gas entering the gas inlets of eductors 502 can continue within capture solution tank 506 to further the reaction to form the mixed fluid.

The reaction progresses in capture solution tank 506 such that both the [OH⁻] in the liquid phase of the mixed fluid and the CO₂ concentration in the gas phase of the mixed fluid decreases while the [CO₃²⁻] in the liquid phase of the mixed fluid increases. The liquid phase of the mixed fluid is collected in capture solution tank 506 as it forms. The gas phase of the mixed fluid is drawn out of capture solution tank 506 into one or more vent stacks by a fan 514.

In some implementations, fan 514 is an induced draft fan. Capture solution tank 506 is mechanically and fluidly coupled to vent stack 544, which comprises some of the same elements as vent stack 244 of FIG. 2. In one implementation, vent stack 544 houses a packed bed absorption column positioned upstream of fan 514, similar to packed bed absorption column 242 of supplemented gas-liquid contactor unit 200. The packed bed absorption column can include structured packing or loose (random) packing and can have the same or similar features as packed bed absorption column 242 of FIG. 2. In some implementations rather than combining regenerated capture solution 532 with second portion of rich capture solution 519, the regenerated capture solution 532 can be directed to flow over the packed bed absorption column to absorb at least a portion of any remaining CO₂ in the mixed fluid that was not absorbed in eductors 502, capture solution tank 506, or upstream units such as mixing chambers in a counterflow reaction. In one implementation, vent stack 544 houses an optional mist eliminator upstream of fan 514 (e.g., similar to mist eliminator 440 of perimetric gas-liquid contactor system 400). The mist eliminator can be a chevron-type mist eliminator that adheres to liquid droplets entrained in the mixed fluid. The gas phase of the mixed fluid can be drawn upwards by fan 514 and discharged as CO₂-lean gas (e.g., a product stream) through CO₂-lean gas outlet 504. It can be beneficial for CO₂-lean gas outlet 504 to be positioned to discharge or to route CO₂-lean gas away from the gas inlets of eductors 502 and from the gas inlets of any adjacent gas-liquid contactor systems. For example, CO₂-lean gas outlet 504 can be positioned to route CO₂-lean gas towards the ground, thereby avoiding CO₂-lean gas from entering the gas inlets of any adjacent gas-liquid contactor units.

Eductors 502 are positioned in rows on capture solution tank 506 and are fluidly coupled to CO₂-lean gas outlet 504 via capture solution tank 506. In implementations where multi-row gas-liquid contactor system 500 is used to capture CO₂ from air, at least some of eductors 502 can be oriented towards prevailing winds to take advantage of increased gas (air) flow.

Multi-row gas-liquid contactor system 500 is illustrated as including two rows of five eductors 502 (or five rows of two eductors 502) and one vent stack 544 fluidly and mechanically coupled to capture solution tank 506. In other implementations, multi-row gas-liquid contactor system 500 can include rows each comprising more or less than two or five eductors 502, and in some cases, multi-row gas-liquid contactor system 500 can include more than two rows of eductors 502. In some implementations, multi-row gas-liquid contactor system 500 can comprise more than one vent stack 544. For example, multi-row gas-liquid contactor system 500 can include two rows of six eductors 502, one intervening row of five eductors 502, and two vent stacks 544. The number and orientation of eductors 502 and vent stacks 544 in multi-row gas-liquid contactor system 500 can be selected based on wind direction, velocity of prevailing winds, target amount of CO₂ captured, footprint sizing constraints, structural limitations of capture solution tank 506, or a combination thereof.

Eductors 502 are fluidly coupled to one another via capture solution distribution line 510. This can be useful if one or more eductor(s) 502 is inactive, as capture solution distribution line 510 can include one or more valves, of either manual or automatic control, to allow lean capture solution 516 to bypass the inactive eductor(s) 502. For example, a valve fluidly coupling an inactive eductor 502 to the capture solution distribution line 510 can be closed to prevent lean capture solution 516 from being provided to the inactive eductor 502. In some implementations, a lean capture solution flow rate in capture solution distribution line 510 can be varied based on a target amount of CO₂ captured. Capture solution tank 506 includes inlets that are operable to receive a make up water stream 520, a make up capture solution stream 522, or a combination of both, in order to maintain a particular lean capture solution 516 concentration or to adjust for evaporative losses. Make up capture solution 522 can compensate for dilution from ingested water or capture solution losses that may occur. Multi-row gas-liquid contactor system 500 can be at least partially constructed of a caustic-compatible material such as thermoplastics, thermoset resins, stainless steel, or a combination thereof. Some examples of suitable thermoplastics include polyvinyl chloride (PVC), chlorinated polyvinyl chloride (CPVC), polytetrafluoroethylene (PTFE). An example of a suitable thermoset resin is brominated bisphenol-A based vinyl ester.

In some cases, at least one of lean capture solution 516, first portion of rich capture solution 518, second portion of rich capture solution 519, make up capture solution 522, and regenerated capture solution 532 can comprise a rate-enhancing additive such as piperazine, carbonic anhydrase, MEA, and DEA. The rate-enhancing additive can move freely in the capture solution or can be immobilized in capsules that move freely in the capture solution. In implementations where the rate-enhancing additive is moving freely, the rate-enhancing additive can be contained within multi-row gas-liquid contactor system 500 and impeded from flowing to a regeneration system 534 by a barrier or a filtration system. In some cases, it can be advantageous for multi-row gas-liquid contactor system 500 to have a number of wetted surfaces coated with a rate-enhancing material. The rate-enhancing material can include a rate-enhancing additive, for example a catalyst or a promoter, that is stabilized on a solid support by immobilization methods. For example, eductors 502, capture solution tank 506, and vent stack 544 can each have a wetted surface that is coated with a rate-enhancing material. In some applications, a combination of a freely moving rate-enhancing additive in the capture solution and a rate-enhancing material coated on surfaces within the gas-liquid contactor can be employed to improve CO₂ uptake.

In some implementations, multi-row gas-liquid contactor system 500 can be communicably coupled to and controlled with a control system 999.

FIG. 6 is a block flow diagram illustrating an example integrated gas capture system 600 including a gas-liquid contactor system 660 fluidly coupled to a regeneration system 638. In gas-liquid contactor system 660, an eductor 602 receives a gas 612 comprising a dilute concentration of CO₂. Gas 612 can include other components such as N₂, O₂, and impurities. Eductor 602 reacts CO₂ in gas 612 by mixing it with a lean capture solution 614 to form a first mixed fluid 619 that has a gas phase and a liquid phase.

The reaction of lean capture solution 614 with CO₂ progresses in eductor 602 such that both the hydroxide concentration [OH⁻] in the liquid phase of first mixed fluid 619 and the CO₂ concentration in the gas phase of first mixed fluid 619 decreases while the carbonate concentration [CO₃²⁻] in the liquid phase of first mixed fluid 619 increases. Eductor 602 discharges first mixed fluid 619 to capture solution tank 604.

In one implementation, mixing can be supplemented by a mixing chamber downstream of eductor 602. For example, a static mixer positioned downstream of eductor 602 can increase turbulent mixing to further react gas 612 and lean capture solution 614 in first mixed fluid 619. In some implementations, rich capture solution 620 and lean capture solution 614 can each include varying ratios of KOH, K₂CO₃, KHCO₃, NaOH, Na₂CO₃, H₂O, or a combination thereof. In some cases, the ratio of carbonate concentration [CO₃²⁻] to hydroxide concentration [OH⁻] can be higher in rich capture solution 620 than in lean capture solution 614. For example, if the [CO₃²⁻] to [OH^{'1}] ratio in lean capture solution 614 less than about 0.4, then the [CO₃²⁻] to [OH⁻] ratio in rich capture solution 620 can be more than about 0.5.

First mixed fluid 619 is discharged from eductor 602 into a capture solution tank 604. Capture solution tank 604 collects the liquid phases of first mixed fluid 619. The reaction of lean capture solution 614 with CO₂ in gas 612 progresses further within capture solution tank 604 to form a second mixed fluid 623 that has a gas phase and a liquid phase. The reaction progresses in capture solution tank 604 such that both the [OH^{'1}] in the liquid phase of second mixed fluid 623 and the CO₂ concentration in the gas phase of second mixed fluid 623 decreases while the [CO₃²⁻] in the liquid phase of second mixed fluid 623 increases. The liquid phase of second mixed fluid 623 is collected in capture solution tank 604 as it forms. The gas phase of second mixed fluid 623 is drawn out of capture solution tank 604 by a fan 634. Fan 634 flows the gas phase of second mixed fluid 623 to a CO₂-lean gas outlet 636 where a CO₂-lean gas 616 is discharged as a product stream.

In one implementation, second mixed fluid 623 is discharged from capture solution tank 604 to a packed bed absorption column. The packed bed absorption column can hold structured packing or loose packing. In some implementations, regenerated capture solution 632 is sent from a regeneration system 638 directly to the top of the packed bed absorption column. Countercurrent flow of second mixed fluid 623 and regenerated capture solution 632 enables further capture of CO₂. In such an implementation, at least a portion of CO₂ that did not react in eductor 602 can be removed by reacting with regenerated capture solution 632.

In one implementation, Benfield chemistry wherein K₂CO₃ is used to remove acid gases, including CO₂, can be employed using integrated dilute gas capture system 600. For example, integrated dilute gas capture system 600 can be employed to carry out chemistry of the Benfield process wherein K₂CO₃ is used to remove acid gases, including CO₂, if downstream units are configured to employ the Benfield chemistry according to reactions of Eq. 5 (e.g., if the regeneration system includes a steam stripper). The regeneration tower can be configured to process a bicarbonate solution.

In one implementation, second mixed fluid 623 is drawn from capture solution tank 604 to a mist eliminator that traps liquid droplets entrained in second mixed fluid 623 before second mixed fluid 623 is discharged as CO₂-lean gas 616 at CO₂-lean gas outlet 636.

Rich capture solution 620 is collected in capture solution tank 604. A first portion 622a of rich capture solution 620 is pumped to an example regeneration system 638 and a second portion 622b of rich capture solution 620 is combined with regenerated capture solution 632 to form lean capture solution 614. Regeneration system 638 comprises a lime causticization system 640 and a calciner 642.

In some implementations, lime causticization system 640 comprises a mixed tank reactor in which the causticizing reaction and slaking reaction occur concurrently in the same reactor. For example, potassium-based reactions defined by Eq. 2 and Eq. 3 can occur concurrently in the mixed tank reactor. The slaking reaction yields hydrated lime (Ca(OH)₂) from reacting water with quicklime CaO. The causticizing reaction yields a concentrated carbon stream, such as a CaCO₃ solids stream 650, and regenerated capture solution 632 from the reactants i) carbonate in the first portion of rich capture solution 620 and ii) hydrated lime Ca(OH)₂. For example, potassium-based reactions defined by Eq. 2 and Eq. 3 can occur concurrently in the mixed tank reactor.

In some implementations, lime causticization system 640 includes a pellet reactor fluidly coupled to a slaker. In this implementation, the causticizing reaction (e.g., Eq. 2) occurs in the pellet reactor and the slaking reaction (e.g., Eq. 3) occurs in the slaker. In the slaker, water reacts with quicklime to yield hydrated lime which is sent to the pellet reactor. The first portion 622a of rich capture solution 620 reacts with hydrated lime in the pellet reactor to yield CaCO₃ solids and regenerated capture solution 632. In some implementations, the pellet reactor forms CaCO₃ solids in the form of pellets and fine particles. Fine particles of CaCO₃ can be separated in a filtration system downstream of lime causticization system 640.

CaCO₃ solids stream 650 are transferred to a calciner 642 and regenerated capture solution 632 is sent to gas-liquid contactor system 660. Calciner 642 calcines the CaCO₃ solids using a high-temperature calcination process, thereby releasing a CO₂-rich gas stream such as CO₂ stream 648 and forming a quicklime (CaO solids) stream 646. In some implementations, calciner 642 can be an electric calciner driven by a power generation system. In some implementations, calciner 642 can be an oxy-fired calciner that is operable to receive an oxygen stream to combust with a fuel (such as natural gas, hydrogen, biogas or biomethane), thereby generating temperatures that are sufficiently high for calcination (e.g., 900° C.). In other implementations, the calciner can be a circulating fluid bed calciner, bubbling bed calciner, rotary calciner, or flash calciner. CO₂ stream 648 may include H₂O, O₂, N₂, impurities, or a combination thereof. CO₂ stream 648 can be discharged from regeneration system 638 and sent to downstream units or systems for further processing. For example, CO₂ stream 648 can be further processed to remove at least some impurities (e.g., O₂, water) and then it can be compressed for downstream applications or pipeline transfer. Either before or after processing, CO₂ stream 648 can be flowed from the calciner 642 in a product conduit 644 extending from the calciner 642. The product conduit 644 may be used to provide the CO₂ stream 648 as a product stream or product gas for use in downstream applications, or as a stand-alone product used for export or as a feedstock. In some implementations, after processing to remove impurities, the CO₂ stream 648 is provided as a substantially pure product stream of CO₂ for use in downstream applications, or as a stand-alone product used for export or as a feedstock. In other implementations of the regeneration system 638, the product conduit 644 is configured to provide different products. Non-limiting examples of products conveyed via the product conduit 644 in different implementations of the regeneration system 638 include carbon products such as CO, ethylene, fuel, methanol, hydrocarbons and CaCO₃ solids, as well as non-carbon products such as quicklime (CaO solids).

Quicklime stream 646 is transferred to the lime causticization system 640. In one implementation, quicklime stream 646 is transferred to a slaker (which may be part of lime causticization system 640), where the CaO is hydrated to form hydrated lime Ca(OH)₂ solids according to the reaction defined by Eq. 3 reproduced below:

CaO₍ₛ₎+H₂O₍ₗ₎→Ca(OH)₂_{₍ₛ₎} (Eq. 3)

In such an implementation, the hydrated lime Ca(OH)₂ solids can be further hydrated to form a slurry, which is then transferred to a pellet reactor to form CaCO₃ solids 650 and a regenerated capture solution 632 is formed according to the reaction defined by Eq. 2 below:

K₂CO₃_{_{(aq)}}+Ca(OH)₂_{₍ₛ₎}→2KOH_{aq}+CaCO₃_{₍ₛ₎} (Eq. 2)

Regenerated capture solution 632 is combined with rich capture solution 620 from capture solution tank 604 to form lean capture solution 614 which is returned to eductor 602.

In some implementations, lean capture solution 614 can further comprise hydroxide reagents instead of KOH, such as NaOH. In other implementations, lean capture solution 614 can comprise amine-based CO₂ capture reagents. In such cases, regeneration system 638 can comprise systems other than lime causticization system 640 and calciner 642 for forming regenerated capture solution 632 and releasing CO₂ 648.

In one implementation, regeneration system 638 comprises an electrochemical processing system that is operable to generate carbon products. For example, regeneration system 638 can comprise some of the elements described in U.S. Pat. Nos. 8,871,008; 8,119,091; and U.S. Patent Application Publication No. 2022/0362707 A1, for example, membrane separation units that are used to separate dissolved target species, such as CO₂, from buffer species in aqueous streams. In some implementations, at least one of lean capture solution 614, rich capture solution 620, make up capture solution 618, and regenerated capture solution 632 can comprise a rate-enhancing additive that can enhance CO₂ capture rate, such as piperazine, carbonic anhydrase, MEA, and DEA. The rate-enhancing additive can be injected upstream of capture solution circulation pump or downstream of stream 632. For example, the rate-enhancing additive can be injected into capture solution tank 604 and combined with rich capture solution in capture solution tank 604. In another example, the rate-enhancing additive can be injected into the capture solution inlets of eductor 602 and combined with lean capture solution in eductor 602.

Integrated dilute gas capture system 600 can include a gas-liquid contactor system 660 comprising multiple eductors 602. For example, gas-liquid contactor system 660 can include elements of and/or be arranged in the same configuration as linear gas-liquid contactor system 300 of FIG. 3, perimetric gas-liquid contactor system 400 of FIG. 4, or multi-row gas-liquid contactor system 500 of FIG. 5. In some implementations, integrated gas capture system 600 can be communicably coupled to and controlled with a control system 999.

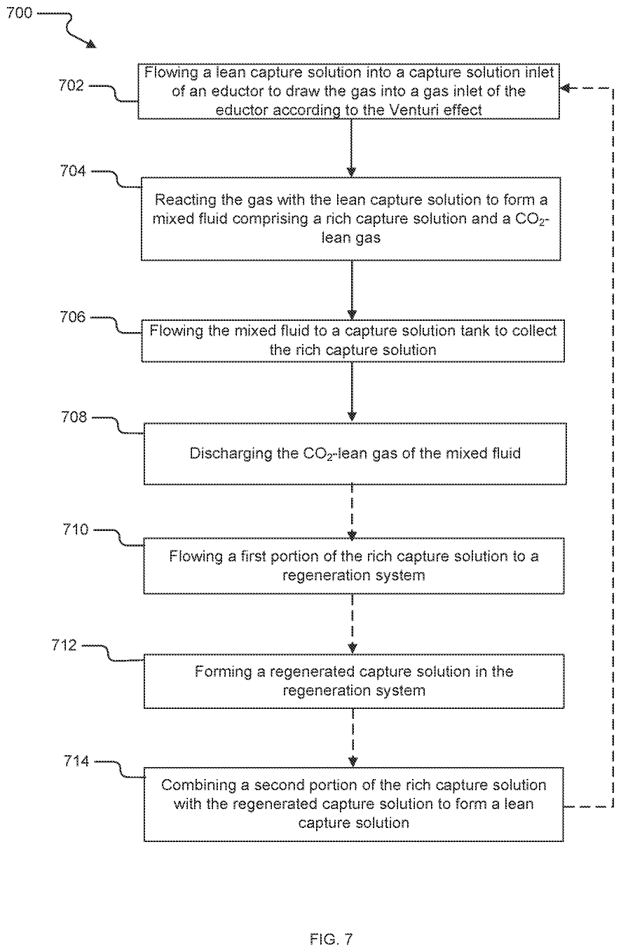

FIG. 7 is a flowchart illustrating a method 700 for removing CO₂ from gas, including dilute gaseous sources such as atmospheric gas, according to at least one implementation of the present disclosure. Method 700 includes steps 702-708, though in other implementations, certain steps can be omitted and/or additional steps can be added. Steps 702-708 can be performed sequentially as illustrated or can be performed in a different order than the illustrated method.

At 702, a lean capture solution is flowed into a capture solution inlet of an eductor. A lean capture solution comprising KOH, K₂CO₃, H₂O, NaOH, Na₂CO₃, or a combination thereof can be flowed into the eductor. In some cases, the lean capture solution can include a rate-enhancing additive such as piperazine, carbonic anhydrase, MEA, or DEA. In some cases, the lean capture solution is flowed into a capture solution inlet of an eductor via a capture solution distribution line.

Flowing the lean capture solution at 702 draws a gas into a gas inlet of the eductor. The gas can be an atmospheric gas comprising a dilute concentration of CO₂. The gas is drawn into the gas inlet of the eductor via the Venturi effect, which is achieved by employing the lean capture solution as a motive fluid in the eductor. In some cases, the Venturi effect of the motive fluid is supplemented by a fan, such as an induced draft fan, to draw the gas into the gas inlet. In some implementations, the gas can include O₂, H₂O, N₂, impurities, or a combination thereof. For example, the gas can comprise a CO₂ concentration of between 300 ppm and 10,000 ppm. In some implementations, the gas can include an exhaust gas originating from an industrial process containing CO₂ concentrations higher than 10,000 ppm and can also include, H₂S, NOx, O₂, impurities, or a combination thereof.

At 704, the lean capture solution and the gas are mixed in a mixing zone within the eductor. Mixing can occur partially in the mixing zone and partially at an outlet of the eductor. The mixing zone of the eductor can be configured for turbulent mixing to promote reaction of the lean capture solution and CO₂ in the gas. For example, the eductor can have textured surfaces to increase turbulent mixing. In cases where a rate-enhancing additive is included in the lean capture solution, the rate-enhancing additive can catalyze or promote a reaction of CO₂ with a reagent in the lean capture solution.

The gas is reacted with the lean capture solution in the mixing zone. For example, some CO₂ in the gas can react with KOH or NaOH in the lean capture solution to form K₂CO₃ or Na₂CO₃, respectively. A portion of the gas may remain unreacted.

A mixed fluid including a rich capture solution and a CO₂-lean gas stream is formed. The mixed fluid has a gas phase and a liquid phase. The mixed fluid can also include the lean capture solution and the gas that was unreacted in prior steps of method 700. As the reaction progresses, the concentration of the rich capture solution and the CO₂-lean gas increases while the concentration of lean capture solution and the gas decreases in the mixed fluid. The mixed fluid can include some of the lean capture solution that was not reacted. The CO₂-lean gas in the gaseous portion of the mixed fluid can include less CO₂ than the gas in step 704. The mixed fluid can be continuously formed as subsequent steps are performed. In some cases, the ratio of carbonate concentration [CO₃²⁻] to hydroxide concentration [OH⁻] can be higher in the rich capture solution than in lean capture solution. For example, if the [CO₃²⁻] to [OH⁻] ratio in the lean capture solution less than about 0.4, then the [CO₃²⁻] to [OH⁻] ratio in the rich capture solution can be more than about 0.5. In some cases, the rich capture solution or the lean capture solution can include a rate-enhancing additive such as piperazine, carbonic anhydrase, MEA, or DEA. In cases where a rate-enhancing additive is included, the rate-enhancing additive can catalyze or promote a reaction of CO₂ with a reagent in the rich capture solution or the lean capture solution.

At 706, the mixed fluid is flowed to a capture solution tank. In one implementation, a preceding step may be performed where the mixed fluid is flowed to a mixing chamber (e.g., a static mixer) to further react at least some of the CO₂ and the lean capture solution remaining in the mixed fluid from preceding steps of method 700.

At 708, the CO₂-lean gas of the mixed fluid is discharged, for example out of a CO₂-lean gas outlet by operating a fan. The CO₂-lean gas outlet may be positioned downstream of the fan. The CO₂-lean gas can be the gas phase of the mixed fluid of 704. In one implementation, an induced draft fan draws the gas phase of the mixed fluid out of the capture solution tank. In some implementations, a preceding step may be performed wherein the mixed fluid is flowed through a mist eliminator to remove liquid droplets entrained in the mixed fluid. In some implementations, a preceding step may be performed wherein the mixed fluid is flowed through a packed bed absorption column and reacted with a regenerated capture solution. In some implementations, the packed bed absorption column can be designed for counterflow absorption (e.g., the mixed fluid and the regenerated capture solution can flow in opposite directions as they react).

In some implementations, the method 700 includes further processing of the rich capture solution to regenerate the rich capture solution. Referring to FIG. 7, at 710, a first portion of the rich capture solution is flowed to a regeneration system. The regeneration system can comprise at least some of the same or similar elements as regeneration system 638 of FIG. 6 or any of the aforementioned implementations of regeneration system 638 of FIG. 6. For example, the regeneration system can comprise a lime causticization system that forms CaCO₃ solids and a calciner which heats the pellets and releases CO₂. In one implementation, the regeneration system can be an electrochemical regeneration system. In some implementations, the regeneration system can include membrane separation units to isolate, increase, and/or purify the concentration of the carbon-containing species.

At 712, a regenerated capture solution is formed in the regeneration system. The regenerated capture solution can be formed using at least the first portion of the rich capture solution. For example, the first portion of the rich capture solution can be sent to a pellet reactor to form CaCO₃ solids and the regenerated capture solution. In some cases, the regenerated capture solution can include a rate-enhancing additive such as piperazine, carbonic anhydrase, MEA, or DEA.

At 714, the regenerated capture solution is combined with a second portion of the rich capture solution to form a lean capture solution. For example, the regenerated capture solution can be combined with the rich capture solution to achieve a KOH molarity ranging from less than 1 molar to about 6 molar in the lean capture solution. The lean capture solution can be returned to the eductor to repeat method 700 starting at 702.

Optionally, method 700 includes a step wherein a make up capture solution, a make up water stream, a rate-enhancing additive, or a combination thereof is flowed into the eductor or the capture solution tank. Each of the above steps can be modified to accommodate CO₂ capture via a different chemistry. For example, Benfield chemistry or amine scrubbing can substitute the KOH-based reactions described in method 700.

Method 700 can include flowing a stream (e.g., mixed fluid, clean gas, rich capture solution, lean capture solution, regenerated capture solution) to at least one auxiliary unit or auxiliary equipment, such as a filtration system, a holding tank, a mixing tank, a settler, a clarifier, a conveyor, or other unit that facilitates the performance of method 700. In cases where the gas carries contaminants, such as NOx and SOx, the gas can be flowed through a pre-treatment unit prior to performing method 700. For example, the gas can be flowed through an amine scrubber prior to step 704 of method 700.

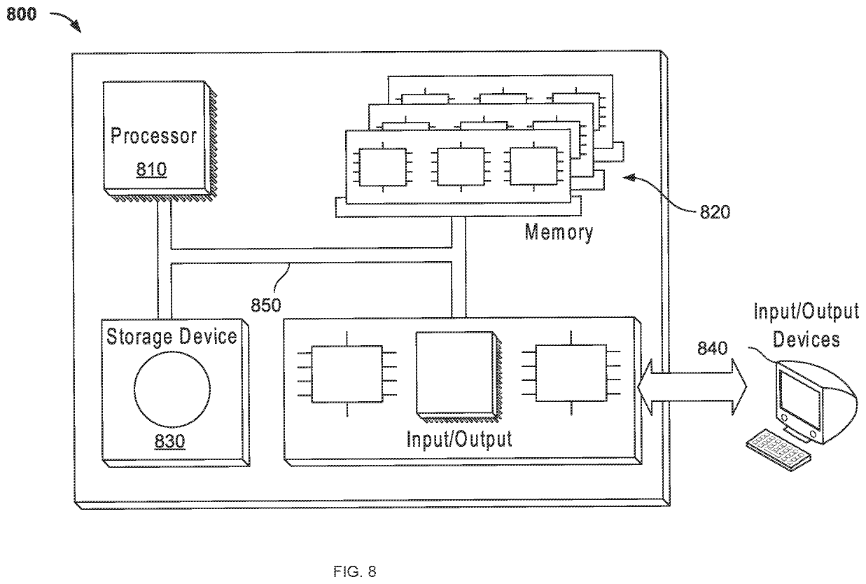

FIG. 8 is a schematic diagram of a control system (or controller) 800 for gas-liquid contactor system, such as units 100 and 200 shown in FIGS. 1 and 2, respectively and/or systems 300-600 in FIGS. 3-6, respectively. The system 800 can be used for the operations described in association with any of the computer-implemented methods described previously, for example as or as part of the control system 999 or other controllers described herein.

The system 800 is intended to include various forms of digital computers, such as laptops, desktops, workstations, personal digital assistants, servers, blade servers, mainframes, and other appropriate computers. The system 800 can also include mobile devices, such as personal digital assistants, cellular telephones, smartphones, and other similar computing devices. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 800 includes a processor 810, a memory 820, a storage device 830, and an input/output device 840. Each of the components 810, 820, 830, and 840 are interconnected using a system bus 850. The processor 810 is capable of processing instructions for execution within the system 800. The processor may be designed using any of a number of architectures. For example, the processor 810 may be a CISC (Complex Instruction Set Computers) processor, a RISC (Reduced Instruction Set Computer) processor, or a MISC (Minimal Instruction Set Computer) processor.

In one implementation, the processor 810 is a single-threaded processor. In some implementations, the processor 810 is a multi-threaded processor. The processor 810 is capable of processing instructions stored in the memory 820 or on the storage device 830 to display graphical information for a user interface on the input/output device 840.

The memory 820 stores information within the system 800. In one implementation, the memory 820 is a computer-readable medium. In one implementation, the memory 820 is a volatile memory unit. In some implementations, the memory 820 is a non-volatile memory unit.

The storage device 830 is capable of providing mass storage for the system 800. In one implementation, the storage device 830 is a computer-readable medium. In various different implementations, the storage device 830 may be a floppy disk device, a hard disk device, an optical disk device, or a tape device.

The input/output device 840 provides input/output operations for the system 800. In one implementation, the input/output device 840 includes a keyboard and/or pointing device. In some implementations, the input/output device 840 includes a display unit for displaying graphical user interfaces.

Certain features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

A number of embodiments of the disclosure have been described. Nevertheless, it will be understood that various modifications may be made without departing from the spirit and scope of the disclosure. Accordingly, other embodiments are within the scope of the following claims. Further modifications and alternative embodiments of various aspects will be apparent to those skilled in the art in view of this description. Accordingly, this description is to be construed as illustrative only. It is to be understood that the forms shown and described herein are to be taken as examples of embodiments. Elements and materials may be substituted for those illustrated and described herein, parts and processes may be reversed, and certain features may be utilized independently, all as would be apparent to one skilled in the art after having the benefit of this description. Changes may be made in the elements described herein without departing from the spirit and scope as described in the following claims.

1. A system for removing carbon dioxide from a gas, the system comprising:
an eductor comprising:
a capture solution inlet operable to receive a lean capture solution;
a gas inlet operable to receive the gas comprising carbon dioxide;
a mixing zone configured to react the lean capture solution and the gas comprising carbon dioxide; and
an eductor outlet operable to discharge a mixed fluid comprising a rich capture solution and a CO₂-lean gas;
a CO₂-lean gas outlet fluidly coupled to the eductor;
a fan fluidly coupled to the CO₂-lean gas outlet, the fan being rotatable to discharge the CO₂-lean gas from the CO₂-lean gas outlet; and
a capture solution tank fluidly coupled to the eductor outlet and to the CO₂-lean gas outlet, the capture solution tank configured to collect the rich capture solution.

2. The system of claim 1, further comprising a regeneration system fluidly coupled to the capture solution tank.

3. The system of claim 2, further comprising a capture solution distribution line fluidly coupled to the capture solution inlet of the eductor and to the regeneration system.

4. The system of claim 2, wherein the capture solution tank is fluidly coupled to the regeneration system via a capture solution circulation pump.

5. The system of claim 2, wherein the regeneration system comprises at least one of a lime causticization system or a calciner.

6. (canceled)

7. (canceled)

8. The system of claim 2, wherein the regeneration system has a product conduit configured to provide the carbon dioxide as a product gas.

9. The system of claim 1, further comprising a mist eliminator fluidly coupled to the CO₂-lean gas outlet.

10. (canceled)

11. (canceled)

12. The system of claim 1, further comprising a mixing chamber fluidly coupled to the eductor outlet.

13. (canceled)

14. (canceled)

15. (canceled)

16. The system of claim 1, further comprising a packed bed absorption column fluidly coupled to the CO₂-lean gas outlet.

17. (canceled)

18. (canceled)

19. (canceled) 20 (Original) The system of claim 1, further comprising a packed bed absorption column and a mist eliminator, wherein the mist eliminator, the packed bed absorption column, the fan and the CO₂-lean gas outlet are spaced apart vertically and sequentially from a lowest position to a highest position as follows: the packed bed absorption column, the mist eliminator, the fan and the CO₂-lean gas outlet.

21. The system of claim 1, further comprising a rate-enhancing material coating on at least one of the eductor, the capture solution tank, or a wetted surface.

22. The system of claim 1, wherein the eductor is operable to flow a lean capture solution comprising a rate-enhancing additive.

23. (canceled)

24. (canceled)

25. The system of claim 1, wherein:
the eductor defines an eductor axis parallel to an axis extending between the capture solution inlet and the eductor outlet; and
the fan is rotatable about a fan axis parallel to the eductor axis.

26. The system of claim 25, wherein the eductor axis and the fan axis are horizontally spaced apart.

27. The system of claim 1, wherein the capture solution tank is disposed beneath the eductor and the fan.

28-54. (canceled)

55. A method for removing carbon dioxide from a gas, the method comprising:
flowing a lean capture solution into a capture solution inlet of an eductor to draw the gas into a gas inlet of the eductor according to the Venturi effect;
reacting the gas with the lean capture solution to form a mixed fluid comprising a rich capture solution and a CO₂-lean gas;
flowing the mixed fluid to a capture solution tank to collect the rich capture solution; and
discharging the CO₂-lean gas of the mixed fluid.

56. The method of claim 55, further comprising regenerating a first portion of the rich capture solution to form a regenerated capture solution.

57. The method of claim 56, further comprising combining a second portion of the rich capture solution with the regenerated capture solution to form the lean capture solution.

58. The method of claim 56, further comprising:
in an absorption column, mixing at least part of the regenerated capture solution and the CO₂-lean gas to capture carbon dioxide from the CO₂-lean gas and to form a rich regenerated capture solution and a CO₂-lean absorber gas; and
discharging the CO₂-lean absorber gas.

59. (canceled)

60. The method of claim 56, wherein regenerating the first portion of the rich capture solution comprises flowing the first portion of the rich capture solution to at least one of a lime causticization system, a pellet reactor, a slaker, or a calciner.

61. (canceled)

62. The method of claim 56, wherein regenerating the first portion of the rich capture solution comprises forming the regenerated capture solution and a concentrated carbon stream.

63. The method of claim 62, further comprising:
releasing a CO₂-rich gas stream from the concentrated carbon stream; and
compressing the CO₂-rich gas stream to form a product stream.

64. (canceled)

65. (canceled)

66. (canceled)

67. (canceled)

68. The method of claim 55, wherein the lean capture solution comprises at least one of an amine, potassium hydroxide, sodium hydroxide, potassium carbonate, bicarbonate, sodium carbonate, or water.

69. (canceled)

70. The method of claim 55, further comprising reducing mist from the CO₂-lean gas before discharging the CO₂-lean gas.

71. The method of claim 55, further comprising, in a packed bed absorption column, mixing at least one of the lean capture solution and the rich capture solution with the CO₂-lean gas to capture carbon dioxide from the CO₂-lean gas.

72. The method of claim 55, further comprising flowing the gas through a pre-treatment unit prior to drawing the gas into the gas inlet of the eductor.

73. The method of claim 55, further comprising flowing a rate-enhancing additive through the eductor.

74. (canceled)

75. (canceled)

76. (canceled)

77. The method of claim 55, wherein flowing the lean capture solution into the capture solution inlet of the eductor to draw the gas into the gas inlet of the eductor comprises flowing the lean capture solution vertically downward and drawing the gas along a horizontal direction into the gas inlet.
